(19) United States
(12) Patent Application Publication
(10) Pub. No.: US 2018/0172458 A1
(43) Pub. Date: Jun. 21, 2018

(54) TRAVEL PLANNING SYSTEM, TRAVEL PLANNING METHOD, AND PROGRAM

(71) Applicant: Hideyuki YAMAMOTO, Kawasaki-shi (JP)

(72) Inventors: Hideyuki YAMAMOTO, Kawasaki (JP); Reiko YAMAMOTO, Kawasaki (JP); Kohhei SHINOZAWA, Tokyo (JP); Kazuki YASUKAWA, Yokohama (JP)

(21) Appl. No.: 15/845,219

(22) Filed: Dec. 18, 2017

(30) Foreign Application Priority Data
Dec. 19, 2016 (JP) 2016-245332

(51) Int. Cl. G01C 21/34; G01C 21/36

(52) U.S. Cl. CPC G01C 21/343; G01C 21/3605; G01C 21/3438; G01C 21/3476

(57) ABSTRACT

To make a travel plan in which a visiting place of a traveler's interest is incorporated, provided is a travel planning system including: a storage unit configured to store at least one interested travel object, each of the at least one interested travel object being information about an interested visiting place of a user and including position information of the interested visiting place; a travel planning unit configured to generate a travel plan including a travel route, by using the position information of the interested visiting place, which is indicated by the at least one interested travel object, the travel route including at least one interested visiting place and being travelable within a specified time frame that is specified by the user; and an operation reception unit configured to output the generated travel plan.

### CLAIM OF PRIORITY

This application claims the priority based on the Japanese Patent Application No. 2016-245332 filed on Dec. 19, 2016. The entire contents of which are incorporated herein by reference for all purpose.

### TECHNICAL FIELD

This application claims the priority based on the Japanese Patent Application No. 2016-245332 filed on Dec. 19, 2016. The entire contents of which are incorporated herein by reference for all purpose.

The present invention relates to a travel planning system and a travel planning method.

### BACKGROUND ART

In Japanese Patent Laid-open Publication No. 2005-44173, there is a description “the travel agency server includes personal travel suggestion means for: setting up a home page of a website on the Internet; transmitting, when access to the home page by the user terminal is detected, a screen on which desired conditions of travel are input/set to the user terminal; receiving the desired conditions of travel from the user terminal via the home page; collecting, when a plurality of plans matching the desired conditions are generated by searching a database that accumulates and holds a plurality of pieces of past travel plan data, vacancy information about facilities to be used in the travel plans from the facility terminals of the facilities; generating a plurality of new travel plans through adjustment of the travel plans that takes the collected vacancy information into account; and transmitting the plurality of newly generated travel plans to the user terminal via the home page”.

### SUMMARY OF INVENTION

### Technical Problem

With the popularization of the Internet, a traveler can now easily obtain the latest and detailed information about a visiting place of his or her interest. However, it is labor-consuming and difficult for a traveler to actually make, by himself or herself, a “made-to-order plan” in which a visiting place of his or her interest is incorporated. A travel company, on the other hand, draws up a travel plan with the use of a database that is held by the travel company, and accordingly has difficulties in providing a highly customized travel plan in which a visiting place of a traveler's interest that is not in the database is incorporated.

The travel agency server of Japanese Patent Laid-open Publication No. 2005-44173 searches past travel plan data. The travel agency server consequently cannot provide a travel plan in which a visiting place of a traveler's interest that is not in the database is incorporated.

It is an object of the present invention to provide a technology for making a travel plan in which a visiting place of a traveler's interest is incorporated.

### Solution to Problem

In order to solve the above-mentioned problem, according to one embodiment of the present invention, there is provided a travel planning system including: a storage unit configured to store at least one interested travel object, each of the at least one interested travel object being information about an interested visiting place of a user and including position information of the interested visiting place; a travel planning unit configured to generate a travel plan including a travel route, by using the position information of the at least one interested visiting place, which is indicated by the interested travel object, the travel route including at least one interested visiting place and being travelable within a specified time frame that is specified by the user; and an operation reception unit configured to output the generated travel plan.

The above-mentioned travel planning system may further include a travel object collection unit configured to receive information about the interested visiting place from a user terminal of the user to store in the storage unit the interested travel object corresponding to the received information about the interested visiting place.

In any one of the above-mentioned travel planning systems, the travel planning unit may be configured to: obtain, for each interested visiting place, a gateway used to access the each interested visiting place; select a combination of an entry zone of the travel route and an exit zone of the travel route out of the at least one obtained gateway; and generate the travel route including the selected entry zone, the at least one interested visiting place, and the selected exit zone, and being travelable within the specified time frame.

In any one of the above-mentioned travel planning systems, the at least one interested travel object may be information about a tour, and include position information of a meeting place and position information of at least one visiting place, and the travel planning unit may be configured to generate the travel route by using the position information of the interested visiting place and the position information of the meeting place, which are indicated by the at least one interested travel object, the travel route including at least one of: the at least one interested visiting place; or the at least one tour, the travel route being travelable within the specified time frame.

In any one of the above-mentioned travel planning systems, the storage unit may be configured to store at least one travel object, each of the at least one travel object being information about a tour, and including position information of a meeting place and position information of at least one visiting place, and the travel planning unit may be configured to obtain, when the interested visiting place fulfils a given condition, at least one travel object as the interested travel object from the storage unit, each of the obtained interested travel object including the interested visiting place and corresponding to the tour; and generate the travel route by using the position information of the interested visiting place and the position information of the meeting place, which are indicated by the at least one interested travel object, the generated travel route including at least one of: the at least one interested visiting place; or the at least one tour, the generated travel route being travelable within the specified time frame.

In any one of the above-mentioned travel planning systems, the travel planning unit may be configured to generate the travel route from which duplication between one of the visiting places included in the tour that is represented by a first interested travel object and the interested visiting place that is represented by a second interested travel object is eliminated.

In any of the above-mentioned travel planning systems, the travel planning unit may be configured to generate the travel route including the at least one interested visiting place, being travelable within the specified time frame, and allowing the user to spend a time at each of the at least one interested visiting place, at least as long as a given utilization time associated with the each of the at least one interested visiting place.

In any one of the above-mentioned travel planning systems, the operation reception unit may be configured to output a timetable, which indicates the generated travel route and in which areas representing the respective interested travel objects are arranged, and to receive from the user a selection of an area prohibited to change a place out of the areas, and the travel planning unit may be configured to modify the travel route while maintaining placement of the interested travel object corresponding to the selected area.

In any one of the above-mentioned travel planning systems, the operation reception unit may be configured to receive from the user an instruction to add an area representing the interested travel object in the timetable, and to receive a selection of the added area as the area prohibited to change the place, and the travel planning unit may be configured to modify the travel route in which the interested travel object corresponding to the added area is included, while maintaining the placement of the interested travel object corresponding to the selected area.

In any one of the above-mentioned travel planning systems, each of the interested travel object may include a score, which is given by the user, the travel planning unit may be configured to generate a plurality of travel routes for the selected entry zone and exit zone, calculate an evaluation value for each of the plurality of travel routes by using the score, and select a travel route based on the calculated evaluation value, and the operation reception unit may be configured to output the selected travel route and the evaluation value of the selected travel route.

In any one of the above-mentioned travel planning systems, the travel planning unit may be configured to generate the travel route including the selected entry zone, the at least one interested visiting place, the selected exit zone, and a necessary time slot to which the user is allowed to set a visiting place, and being travelable within the specified time frame.

In any one of the above-mentioned travel planning systems, the storage unit may be configured to store at least one travel object, each of the at least one travel object being information about a visiting place and including position information of the visiting place, the operation reception unit may be configured to output a timetable, which indicates the generated travel route and in which an area representing the necessary time slot is included, and to receive from the user a selection of the area, the travel planning unit may be configured to obtain at least one travel object corresponding to the visiting place when the area is selected, and the operation reception unit may be configured to output a list of visiting places represented by the at least one obtained travel object.

In any one of the above-mentioned travel planning systems, the travel planning unit may be configured to determine, when the area is selected, whether or not the visiting place fulfilling a first condition is included in the generated travel route, and to obtain at least one travel object corresponding to the visiting place that fulfills a second condition when no visiting place fulfilling the first condition is included in the generated travel route.

In any one of the above-mentioned travel planning systems, the storage unit may be configured to store at least one travel object, each of the at least one travel object being information about a tour, and including position information of a meeting place and position information of the at least one visiting place, the operation reception unit may be configured to receive, from the user, an instruction to set the visiting place to the selected area, the travel planning unit may be configured to obtain, from the storage unit, when the visiting place received from the user fulfills a given condition, at least one travel object corresponding to the tour in which the received visiting place is included, and the operation reception unit may be configured to output a list of tours indicated by the at least one obtained travel object.

In any one of the above-mentioned travel planning systems, the storage unit may be configured to store the at least one interested travel object for each of a plurality of users who belong to the same group, and the travel planning unit may be configured to: obtain, when generating the travel plan for the group, at least one interested travel object of the group by consolidating the same interested travel object of the plurality of users who belong to the group into one; and generate the travel route by using the position information of the at least one interested visiting place that is represented by the interested travel object obtained for the group, the generated travel route including the at least one interested visiting place and being travelable within a specified time frame, which is specified by the group.

In any one of the above-mentioned travel planning systems, each of the interested travel object may include a score given by the user, the travel planning unit may be configured to: calculate, when generating the travel plan for the group, the score of the consolidated interested travel object from the scores given by the plurality of users; and generate a plurality of travel routes, calculate, for each of the plurality of generated travel routes, an evaluation value from the score, and select one of the plurality of generated travel routes based on the calculated evaluation value, and the operation reception unit may be configured to output the selected one of the plurality of generated travel routes and the evaluation value of the selected one of the plurality of generated travel routes.

In order to solve the above-mentioned problem, according to another embodiment of the present invention, there is provided a travel planning method, which is executed by a travel planning system, the travel planning method including: obtaining at least one interested travel object, each of the at least one interested travel object being information about an interested visiting place of a user and including position information of the interested visiting place; generating a travel plan including a travel route, by using the position information of the at least one interested visiting place, which is indicated by the interested travel object, the travel route including at least one interested visiting place and being travelable within a specified time frame that is specified by the user; and outputting the generated travel plan.

In order to solve the above-mentioned problem, according to still another embodiment of the present invention, there is provided a program for a travel planning system, the program causing the travel planning system to function as: a storage unit configured to store at least one interested travel object, each of the at least one interested travel object being information about an interested visiting place of a user and including position information of the interested visiting place; a travel planning unit configured to generate a travel plan including a travel route, by using the position information of the at least one interested visiting place, which is indicated by the interested travel object, the travel route including at least one interested visiting place and being travelable within a specified time frame that is specified by the user; and an operation reception unit configured to output the generated travel plan.

### Advantageous Effects of Invention

According to the present invention, it is possible to make a travel plan in which a visiting place of a traveler's interest is incorporated.

### BRIEF DESCRIPTION OF DRAWINGS

FIG. 1 is a block diagram for illustrating an example of the configuration of a travel planning system according to an embodiment of the present invention.

FIG. 2 is a diagram (Part 1) for illustrating an example of the configuration of a travel object table in the embodiment.

FIG. 3 is a diagram (Part 2) for illustrating an example of the configuration of the travel object table in the embodiment.

FIG. 4 is a diagram (Part 3) for illustrating an example of the configuration of the travel object table in the embodiment.

FIG. 5 is a diagram for illustrating an example of the configuration of a tour information table in the embodiment.

FIG. 6 is a diagram for illustrating an example of the configuration of an interested travel object table in the embodiment.

FIG. 7 is a diagram for illustrating an example of the configuration of a gateway information table in the embodiment.

FIG. 8 is a diagram for illustrating an example of the configuration of a travel plan table in the embodiment.

FIG. 9 is a block diagram for illustrating an example of the hardware configuration of the travel planning system according to the embodiment.

FIG. 10 is a flow chart for illustrating an example of travel planning processing in the embodiment.

FIG. 11 is a flow chart for illustrating an example of processing that is executed in Step S1 of FIG. 10.

FIG. 12A, FIG. 12B, and FIG. 12C are explanatory diagrams for illustrating an example of gateway obtaining processing in the embodiment.

FIG. 13 is a flow chart for illustrating an example of processing that is executed in Step S2 of FIG. 10.

FIG. 14 is a flow chart for illustrating an example of processing that is executed in Step S4 of FIG. 10.

FIG. 15 is a flow chart for illustrating an example of processing that is executed in Step S44 of FIG. 14.

FIG. 16A, FIG. 16B, FIG. 16C, FIG. 16D, FIG. 16E, and FIG. 16F are explanatory diagrams for illustrating an example of travel route search processing in the embodiment.

FIG. 17 is a flow chart for illustrating an example of processing that is executed in Step S5 of FIG. 10.

FIG. 18 is a diagram for illustrating an example of a screen on which a list of travel plans is displayed in the embodiment.

FIG. 19 is a diagram for illustrating an example of a screen on which the timetable of a travel plan is displayed in the embodiment.

FIG. 20 is a diagram for illustrating another example of the screen on which the timetable of a travel plan is displayed in the embodiment.

FIG. 21 is a diagram for illustrating still another example of the screen on which the timetable of a travel plan is displayed in the embodiment.

FIG. 22 is a diagram for illustrating yet another example of the screen on which the timetable of a travel plan is displayed in the embodiment.

FIG. 23 is a diagram for illustrating further another example of the screen on which the timetable of a travel plan is displayed in the embodiment.

### DESCRIPTION OF EMBODIMENTS

Now, an embodiment of the present invention is described with reference to the drawings.

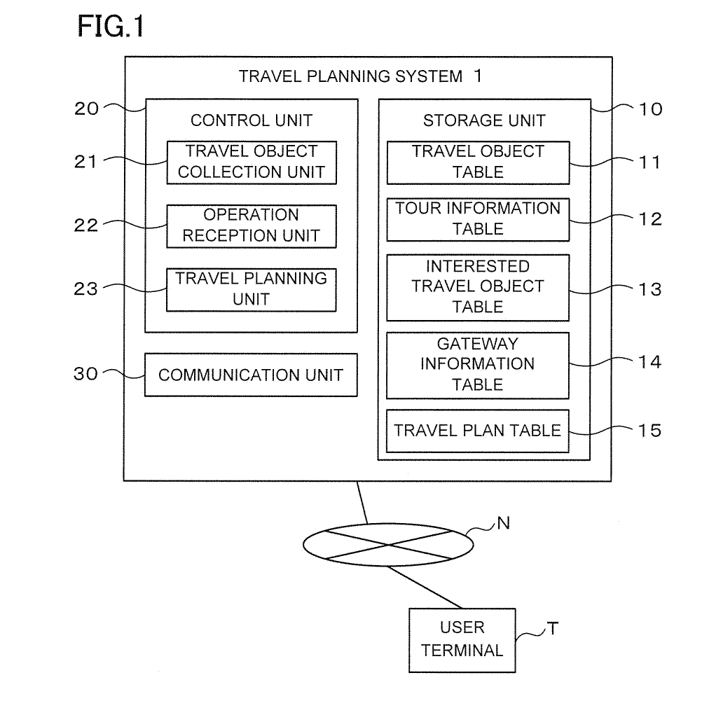

FIG. 1 is a block diagram for illustrating an example of the configuration of a travel planning system according to the embodiment.

A travel planning system 1 is connected to a communication network N, which is the Internet or the like, and is capable of holding communication to and from at least one external device connected to the communication network N, for example, a user terminal T. The travel planning system 1 is an information processing system configured to provide travel plans to each user (who is also a “traveler”), and can be implemented by, for example, a World Wide Web (Web) system including a Web server, a Web application, and a database. Each user terminal T is an information processing device operated by a user of the user terminal T, and can be implemented by, for example, a personal computer (PC), a smartphone, a tablet computer, a wearable device, or a similar device.

At least one information processing system (not shown) configured to provide various functions and various types of information is connected to the communication network N. The at least one information processing system is, for example, a Web system including a Web server, a Web application, and a database. The travel planning system 1 can obtain various types of information by utilizing, for example, a Web application programming interface (API) published by the at least one information processing system.

Examples of information that can be obtained by utilizing the Web API include route information about a route between a set departure place and a set destination (a route that uses at least one mode of transportation selected from airplanes, railways, ships, automobiles, and others), information about the base of transportation (an airport, a train station, a harbor, a bus stop, or the like) nearest to a set place, the vacancy status of a lodging facility at a set date and time, and the seat availability status of a mode of transportation at a set date and time. The travel planning system 1 may use a search engine to search for Web pages and obtain various types of information from the found Web pages.

In this embodiment, the user installs application software (app) capable of holding communication to and from the travel planning system 1 on the user terminal T. The app has, for example, functions of a Web browser and the function of transmitting information that is selected from Web page content displayed on the Web browser to the travel planning system 1. As a matter of course, a plugin incorporated in a Web browser that comes with the user terminal T may be used instead of the app. The plugin has the function of transmitting information that is selected from Web page content displayed on the Web browser to the travel planning system 1.

The user may find a visiting place of his or her interest (hereinafter referred to as “interested visiting place”), for example, a tourist attraction, a sightseeing tour, a restaurant, or a hotel, while surfing the Web or on other occasions. Interested visiting places may be scattered allover the world. The user uses the function of the app or the plugin described above to select information about an interested visiting place in displayed Web page content, for example, the name, location, photographs, and position information of the interested visiting place. The app or the plugin transmits the selected information of the interested visiting place to the travel planning system 1.

The travel planning system 1 receives the selected information of the interested visiting place from the app or the plugin on the user terminal T and stores the information in a database. The travel planning system 1 can hold a list of interested visiting places of the user in this manner. While general users who have found visiting places of their interests tend to forget about the interested visiting places with time, a user who has registered a visiting place of his or her interest to the list in the travel planning system 1 can easily remember the interested visiting place.

A user who wishes to go on a trip that stops at at least one interested visiting place uses the app or the plugin on the user terminal T to instruct the travel planning system 1 to draw up a travel plan. The app or the plugin receives the time frame of the travel from the user, and transmits the time frame to the travel planning system 1 along with the instruction to draw up a travel plan. In this embodiment, in the instruction to draw up a travel plan, the user only needs to input the time frame of the travel.

When the travel planning system 1 receives the instruction to draw up a travel plan from the user, the travel planning system 1 draws up a travel plan in which at least one interested visiting place that is selected from the interested visiting place list held by the travel planning system 1 is incorporated. In this manner, the travel planning system 1 can efficiently draw up a travel plan in which the user's interested visiting place is incorporated.

Incidentally, some interested visiting places are places difficult to access for which route information cannot be found by a route search service that is provided via the Web API described above, for example, a hot spring in the heart of the mountains, a waterfall in a nature reserve, and other similar tourist attractions. However, there may be a sightseeing tour that visits a hard-to-access tourist attraction despite the difficulty of access. In this sightseeing tour, the tourist attraction can be accessed by a chartered mode of transportation, for example. In the case of a visiting place difficult to access, the travel planning system 1 therefore searches for a sightseeing tour that includes this visiting place and incorporates the tour in the travel plan. The travel planning system 1 can thus provide the user a wider range of travel plan options in which the user's interested visiting place is incorporated.

The travel planning system 1, which implements the functions described above, includes a storage unit 10, a control unit 20, and a communication unit 30. The storage unit 10 is configured to store information that is used in processing executed by the control unit 20. The control unit 20 is configured to perform overall control of the travel planning system 1. The communication unit 30 is configured to transmit/receive information to/from the user terminal T and other external devices over the communication network N.

The storage unit 10 stores, for example, a travel object table 11, a tour information table 12, an interested travel object table 13, a gateway information table 14, and a travel plan table 15.

The travel object table 11 stores, in addition to information about an interested visiting place of the user, information about a visiting place that can be selected by the user as an interested visiting place. The term “travel object” (hereinafter also abbreviated as “TO”) means a visiting place and information about the visiting place. The definition of a travel object may include a sightseeing tour in which at least one place is visited, as well as a single visiting place, for example, a tourist attraction, a restaurant, or a hotel.

The tour information table 12 stores information about a sightseeing tour that is stored in the travel object table 11.

The interested travel object table 13 stores information about an interested visiting place of the user. The term “interested travel object” (hereinafter also abbreviated as “ITO”) means an interested visiting place of the user and information about the interested visiting place. The definition of an interested travel object may include a sightseeing tour in which at least one place is visited, as well as a single visiting place, for example, a tourist attraction, a restaurant, or a hotel.

The gateway information table 14 stores information about a gateway. The term “gateway (GW)” means a base of transportation for accessing a visiting place, for example, an airport, a train station, a harbor, or a bus stop.

The travel plan table 15 stores information about a travel plan generated for the user by the travel planning system 1.

The control unit 20 includes, for example, a travel object collection unit 21, an operation reception unit 22, and a travel planning unit 23.

The travel object collection unit 21 is configured to collect information about a visiting place (e.g., the name and position information) by searching the Internet via the communication unit 30, generate a travel object corresponding to the visiting place with the use of the received information, and register the generated object in the travel object table 11. The travel object collection unit 21 may collect information by, for example, using a search engine technology, or receiving input of information from a system administrator.

The travel object collection unit 21 is also configured to receive information about an interested visiting place that is selected by the user from the app or the plugin on the user terminal T via the communication unit 30, generate an interested travel object corresponding to the interested visiting place with the use of the received information, and register the generated object in the interested travel object table 13. The travel object collection unit 21 registers an interested travel object in the interested travel object table 13 in association with one of travel objects registered in the travel object table 11.

The operation reception unit 22 is configured to receive, via the communication unit 30, the user's operation input to the app or the plugin on the user terminal T. The operation reception unit 22 may generate page information of a Web page for receiving operation input, and transmit the page information to the user terminal T via the communication unit 30. The user terminal T displays the Web page by following the received page information.

The travel planning unit 23 is configured to generate a travel plan that fulfills the user's specified condition (the time frame of the travel) and that has a higher evaluation value based on the quality and number of interested travel objects, by executing travel planning processing, which is described later. The travel planning unit 23 is configured to store a generated travel plan in the travel plan table 15.

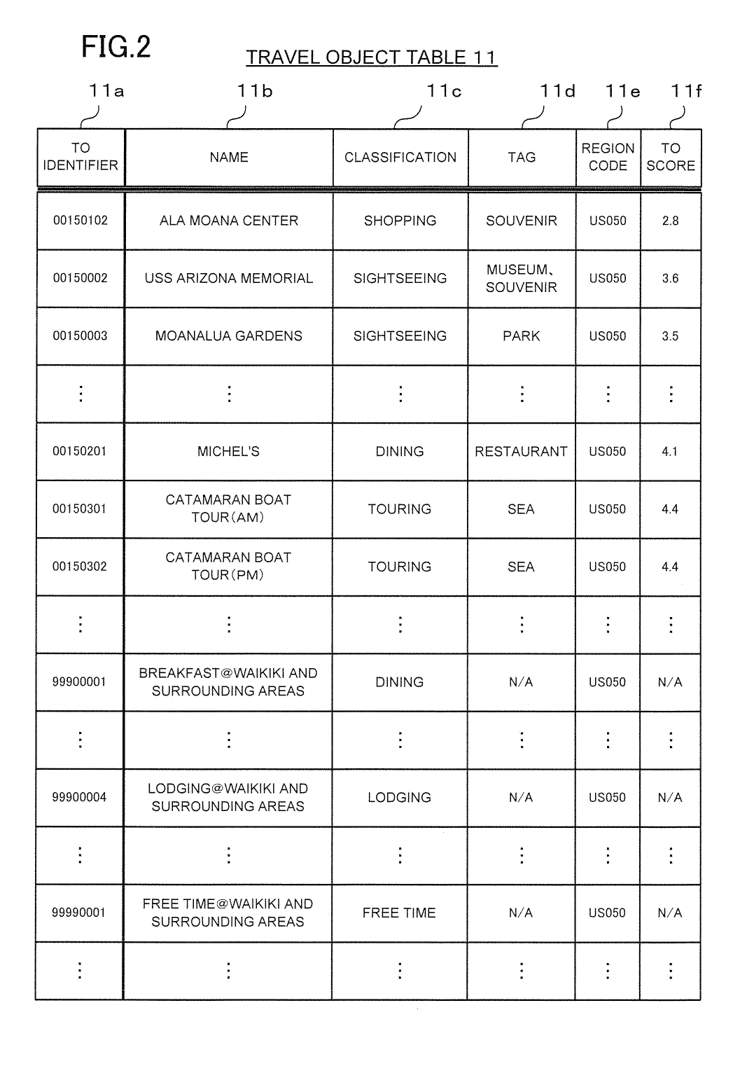

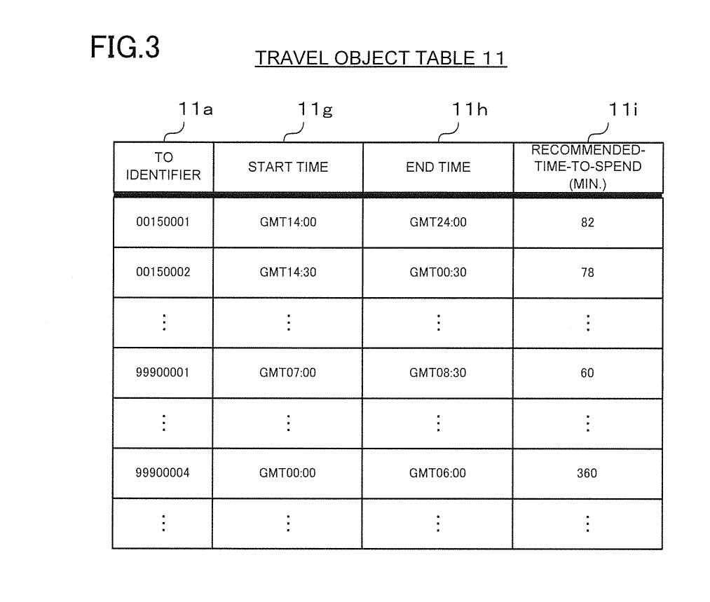

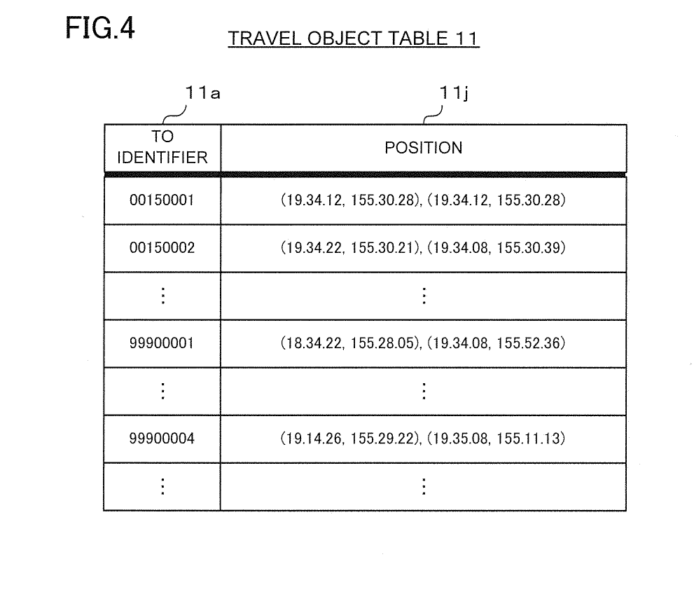

FIG. 2 is a diagram (Part 1) for illustrating an example of the configuration of the travel object table in the embodiment. FIG. 3 is a diagram (Part 2) for illustrating an example of the configuration of the travel object table in the embodiment. FIG. 4 is a diagram (Part 3) for illustrating an example of the configuration of the travel object table in the embodiment.

The travel object table 11 stores a record for each travel object. Each record includes a TO identifier 11a, a name 11b, a classification 11c, a tag 11d, a region code 11e, a TO score 11f, a start time 11g, an end time 11h, a recommended-time-to-spend 11i, and a position 11j.

The TO identifier 11a is the identifier of the travel object. The name 11b is the name of the travel object, for example, the name of a visiting place, which is a tourist attraction, a restaurant, or the like, or the name of a sightseeing tour. The classification 11c is the classification of the purpose of the travel object, for example, shopping, sightseeing, dining, touring, or lodging. The tag 11d indicates features of the travel object, for example, merchandise available for purchase, a famous spot, the type of the eating facility, or key points of the tour. The region code 11eis the code of a region in which the travel object is situated. The TO score 11f is the score of the travel object. The TO score 11f is set based on, for example, the result of aggregating points that have been given to the travel object by a plurality of users.

The start time 11g is a time at which the business hours of the travel object start. The end time 11h is a time at which the business hours of the travel object end. The recommended-time-to-spend 11i indicates how long general users spend at the travel object. As the start time 11g and the end time 11h, the start time and end time of business hours of a tourist attraction or a facility can be set for the tourist attraction or the facility, and a scheduled start time and end time of a sightseeing tour can be set for the sightseeing tour, for example. As the recommended-time-to-spend 11i, an average staying time of a tourist attraction or a facility can be set for the tourist attraction or the facility, and a time required to complete the schedule of a sightseeing tour can be set for the sightseeing tour, for example.

The position 11j is position information of the travel object. The position information is, for example, longitude and latitude or other types of coordinate information on the map. When the position of the travel object is expressed as a point, the position information includes, for example, coordinate information of the point. When the position of the travel object is expressed as a rectangular region, the position information includes, for example, coordinate information of a start point of the rectangular region and coordinate information of an end point of the rectangular region, and the two points correspond to diagonal vertices of the rectangular region. As a matter of course, the shape of the region is not limited to rectangular, and the region may have a circular shape, a polygonal shape, or other shapes.

Information in the travel object table 11 is generated, and registered or updated, by the travel object collection unit 21, for example. The system administrator may instead register or update information in the travel object table 11. The travel planning unit 23 can read information about a travel object, which is a visiting place, a sightseeing tour, or the like, by referring to the travel object table 11. It can be regarded that each record includes information of a corresponding record in another table via the identifier.

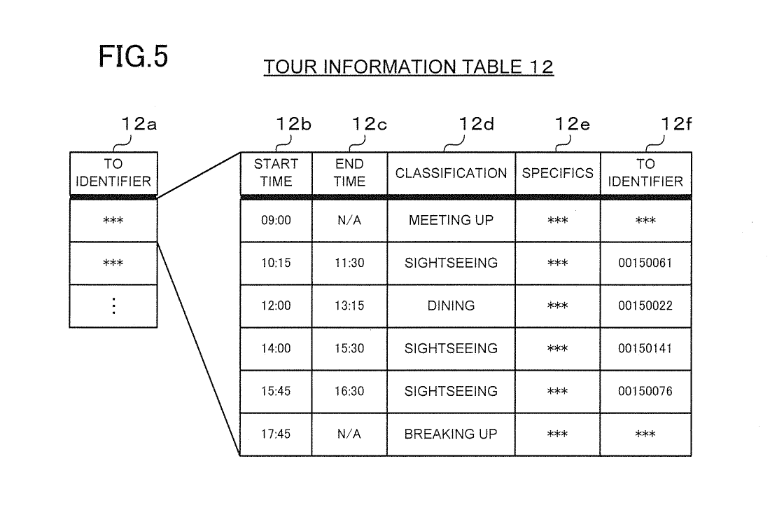

FIG. 5 is a diagram for illustrating an example of the configuration of the tour information table in the embodiment.

The tour information table 12 stores, for each travel object that is a sightseeing tour, schedule information of the tour. A TO identifier 12a is the identifier of a travel object that is a sightseeing tour. The TO identifier 12a corresponds to the TO identifier or the ITO identifier in other tables. At least one schedule item is stored as the schedule information. Each schedule item includes a start time 12b, an end time 12c, a classification 12d, specifics 12e, and a TO identifier 12f.

The start time 12b is a time at which the schedule item is started. The end time 12c is a time at which the schedule item is ended. The classification 12d is the classification of the purpose of the schedule item, for example, meeting up, shopping, sightseeing, dining, or breaking up. The specifics 12e are details of the schedule item. The TO identifier 12f is the TO identifier of a travel object that is associated with the schedule item. For example, the TO identifier of a travel object that is a tourist attraction is set as the TO identifier 12f when the schedule item is “sightseeing”, the TO identifier of a travel object that is an eatery is set as the TO identifier 12f when the schedule item is “dining”, the TO identifier of a travel object that is a meeting place is set as the TO identifier 12f when the schedule item is “meeting up”, and the TO identifier of a travel object that is a breakup place is set as the TO identifier 12f when the schedule item is “breaking up”.

Information in the tour information table 12 is generated, and registered or updated, by the travel object collection unit 21. The system administrator may instead register or update information in the tour information table 12. The travel planning unit 23 can read schedule information of a travel object that is a sightseeing tour by referring to the tour information table 12.

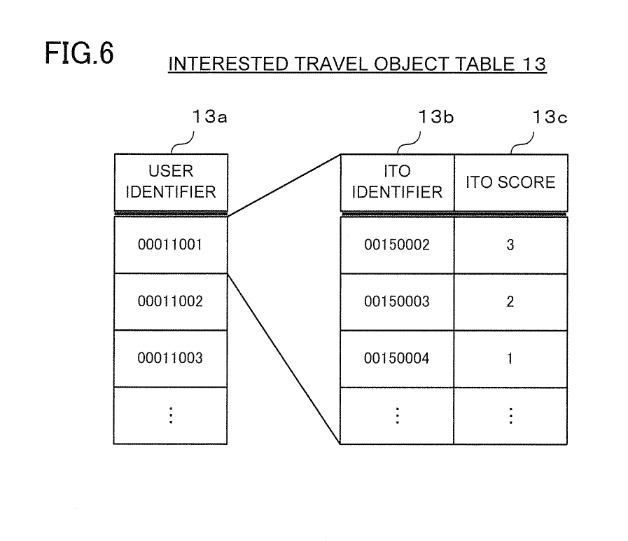

FIG. 6 is a diagram for illustrating an example of the configuration of the interested travel object table in the embodiment.

The interested travel object table 13 stores, for each user, a record of each interested travel object of the user. A user identifier 13a corresponds to the user identifier in other tables. Each record includes an ITO identifier 13b and an ITO score 13c.

The ITO identifier 13b is the identifier of the interested travel object. The ITO identifier 13b corresponds to the TO identifier or the ITO identifier in other tables. The ITO score 13c is the score of the interested travel object. The ITO score 13c is rated by, for example, the user.

Information in the interested travel object table 13 is, for example, generated by the travel object collection unit 21 with the use of information transmitted from the user terminal T about an interested visiting place, and is registered or updated by the travel object collection unit 21. The travel planning unit 23 can read information about an interested travel object, which is an interested visiting place, a sightseeing tour, or the like, by referring to the interested travel object table 13. It can be regarded that each record includes information of a corresponding record in another table via the identifier.

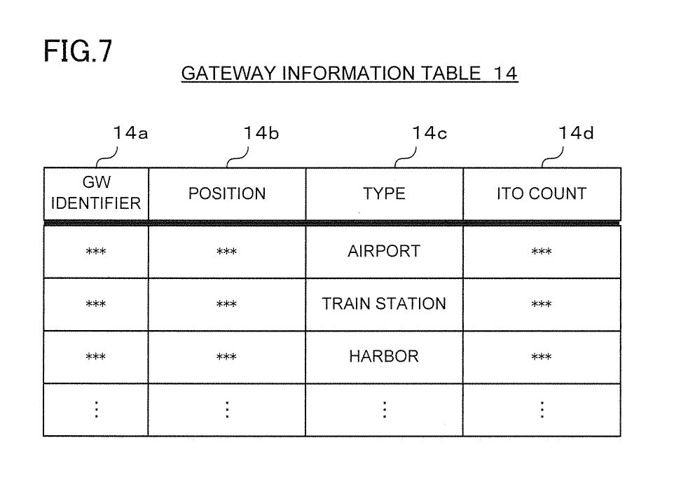

FIG. 7 is a diagram for illustrating an example of the configuration of the gateway information table in the embodiment.

The gateway information table 14 stores a record for each gateway. Each record includes a GW identifier 14a, a position 14b, a type 14c, and an ITO count 14d. The GW identifier 14a is the identifier of the gateway. The position 14b is position information of the gateway. The position information has the same format as that of the position 11j described above. The type 14c is the type of the gateway, for example, airport, train station, harbor, or bus stop. The ITO count 14d is the number of interested travel objects located at positions that fulfil a given condition with respect to the position of the gateway. For example, the number of interested travel objects (interested travel objects of at least one user) from which the position of the gateway is reached by the shortest route is set as the ITO count 14d.

Information in the gateway information table 14 (the GW identifier 14a, the position 14b, and the type 14c) is, for example, generated, and registered or updated, by the travel object collection unit 21. The travel planning unit 23 registers or updates information in the gateway information table 14 (the ITO count 14d) when a travel plan is drawn up for each user as described later. Alternatively, the system administrator may register or update information in the gateway information table 14. The travel planning unit 23 can read information about a gateway by referring to the gateway information table 14.

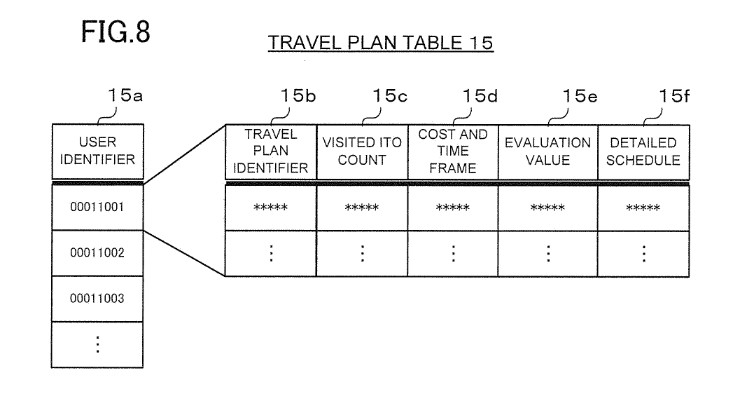

FIG. 8 is a diagram for illustrating an example of the configuration of the travel plan table in the embodiment.

The travel plan table 15 stores, for each user, travel plan information of each travel plan of the user. A user identifier 15a corresponds to the user identifier in other tables. Each piece of travel plan information includes a travel plan identifier 15b, a visited ITO count 15c, a cost and time frame 15d, an evaluation value 15e, and a detailed schedule 15f.

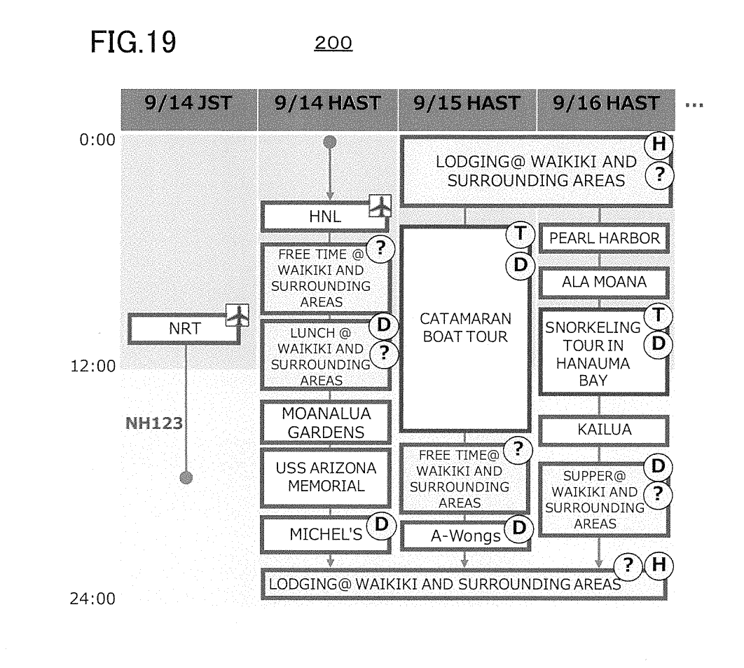

The travel plan identifier 15b is the identifier of the travel plan. The visited ITO count 15c is the number of interested visiting places planned to be visited in the travel plan. The cost and time frame 15d is a cost required for a travel that is planned by the travel plan and the time frame of the planned travel. The evaluation value 15e is the evaluation value of the travel plan, and is calculated by the travel planning unit 23. The detailed schedule 15f is a detailed schedule of the travel plan. The specifics of the detailed schedule 15f are not particularly limited, but includes data used to display a timetable, for example, a timetable illustrated in FIG. 19.

Information in the travel plan table 15 is generated, and registered or updated, by the travel planning unit 23, for example. The travel planning unit 23 can read information about a travel plan by referring to the travel plan table 15.

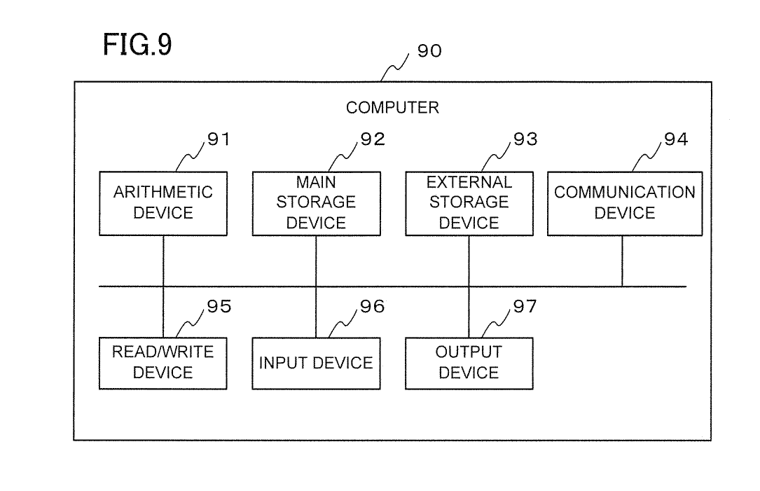

FIG. 9 is a block diagram for illustrating an example of the hardware configuration of the travel planning system according to the embodiment.

The travel planning system 1 can be implemented by a computer 90 as the one illustrated in FIG. 9. The computer 90 is a server computer, for example. Other computer devices including personal computers, smartphones, and tablet computers may also be used as the computer 90. The travel planning system 1 may be built from a plurality of computers.

The computer 90 includes an arithmetic device 91, a main storage device 92, an external storage device 93, a communication device 94, a read/write device 95, an input device 96, and an output device 97.

The arithmetic device 91 is an arithmetic unit, for example, a central processing unit (CPU). The main storage device 92 is a random access memory (RAM) or a similar storage device. The external storage device 93 is a hard disk or a solid state drive (SSD), or a flash read only memory (ROM), or a similar storage device. The communication device 94 is a device configured to transmit and receive information, and the definition of this device includes a communication device configured to hold wired communication via a network cable and a communication device configured to hold wireless communication via an antenna. The read/write device 95 is a device configured to read/write information in a digital versatile disc (DVD), a universal serial bus (USB) memory, and a similar recording medium. The input device 96 is a device configured to receive input information, and the definition of this device includes a keyboard, a mouse or a similar pointing device, a touch panel, a microphone, and the like. The output device 97 is a device configured to output a piece of output information, and the definition of this device includes a display, a printer, a speaker, and the like. At least a part of the main storage device 92 and the external storage device 93 may be implemented by, for example, storage on a network connected via the communication device 94.

The storage unit 10 is implemented by the external storage device 93, for example. The control unit 20 is implemented by the arithmetic device 91, for example. Specifically, the control unit 20 is implemented by, for example, executing a given application program on the arithmetic device 91. This application program is stored in, for example, the external storage device 93. When the application program is to be executed, the application program is loaded onto the main storage device 92 to be executed by the arithmetic device 91. The communication unit 30 is implemented by the communication device 94, for example.

A specific example of travel planning processing executed by the above-mentioned travel planning system 1 is described next. The processing described here is for one target user. Information is already set in the travel object table 11, the tour information table 12, the interested travel object table 13, and the gateway information table 14.

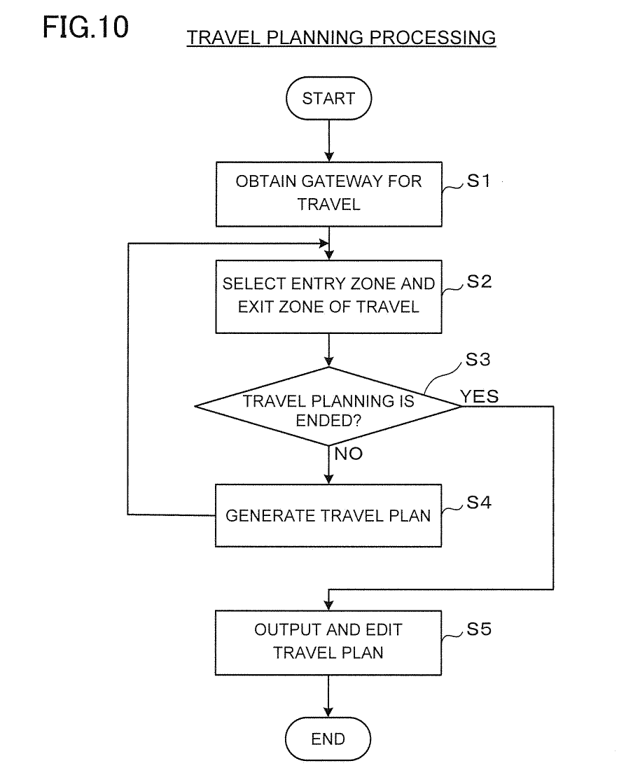

FIG. 10 is a flow chart for illustrating an example of the travel planning processing in the embodiment. The travel planning unit 23 starts processing illustrated in this flow chart when, for example, an instruction to start drawing up a travel plan is received from the user terminal T via the operation reception unit 22. At this point, the travel planning unit 23 receives a specified condition (the time frame of the travel) of the target user. The travel time frame includes, for example, a start date and an end date.

The travel planning unit 23 first obtains gateways of the travel (Step S1). In the processing of Step S1, the travel planning unit 23 obtains a gateway for each interested travel object of the target user. Details of Step S1 are described later.

The travel planning unit 23 next selects an entry zone and exit zone of the travel (Step S2). The term “entry zone” means a base at which the travel is started and which is selected from among gateways. The term “exit zone” means a base at which the travel is ended and which is selected from among gateways. The entry zone and the exit zone may be the same base. In the processing of Step S2, the travel planning unit 23 selects a combination of an entry zone and an exit zone from among the gateways obtained in Step S1. Details of Step S2 are described later.

The travel planning unit 23 next determines whether to end travel planning or not (Step S3). The travel planning unit 23 determines that travel planning is to be ended when a travel planning ending flag, which is described later, is set (Step S3: YES), and advances the processing to Step S5. When the ending flag is not set, the travel planning unit 23 determines that travel planning is to be continued (Step S3: NO), and advances the processing to Step S4.

When travel planning is to be continued, the travel planning unit 23 generates a travel plan (Step S4). In the processing of Step S4, the travel planning unit 23 generates a travel plan that is for a travel from and to the entry zone and exit zone selected in Step S2 and that includes at least one interested travel object. The generated travel plan fulfills the user's specified condition (the time frame of the travel) and has a higher evaluation value based on the quality and number of interested travel objects. Details of Step S4 are described later.

After Step S4, the travel planning unit 23 returns the processing to Step S2, in which another combination of one entry zone and one exit zone is selected.

When travel planning is to be ended, the travel planning unit 23 outputs and edits each travel plan (Step S5). In the processing of Step S5, the travel planning unit 23 outputs information about the at least one travel plan drawn up in Step S4 to the user terminal T via the operation reception unit 22. The travel planning unit 23 receives an edit made to the at least one travel plan from the user terminal T via the operation reception unit 22.

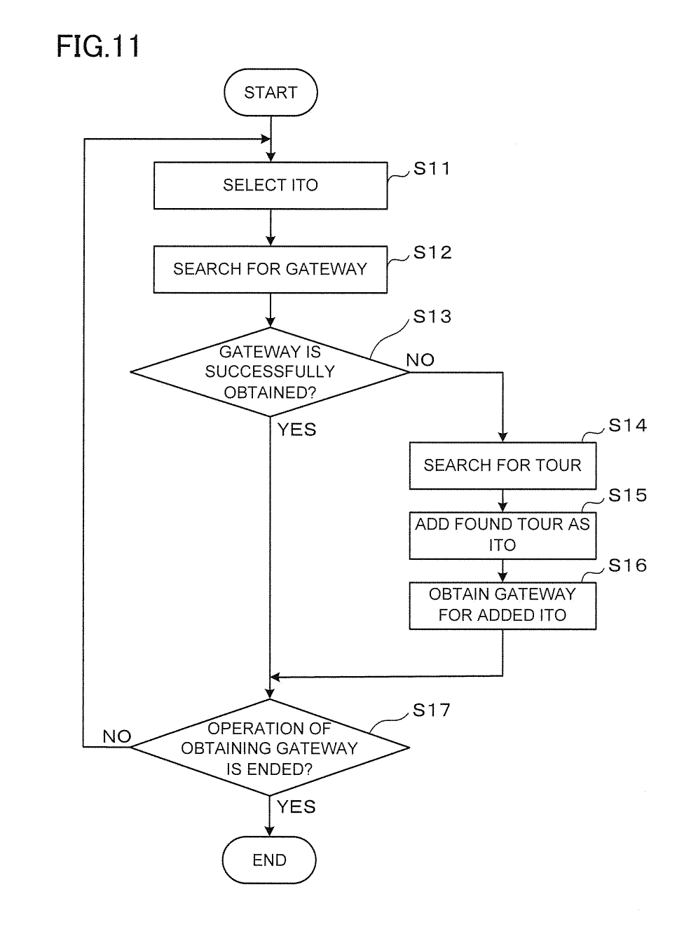

FIG. 11 is a flow chart for illustrating an example of the processing of Step S1 of FIG. 10.

The travel planning unit 23 first copies each record of ITO of the target user from the interested travel object table 13 to a given storage area (not shown, and hereinafter referred to as “candidate travel object table”) in the storage unit 10.

The travel planning unit 23 then selects one ITO (Step S11). Specifically, the travel planning unit 23 refers to the candidate travel object table, selects one of the ITOs, and reads the ITO identifier of the selected ITO. The travel planning unit 23 also refers to the travel object table 11 to read, as the position of the ITO, the position 11j that is associated with the TO identifier 11a corresponding to the read ITO identifier.

The travel planning unit 23 then searches for a gateway (Step S12). Specifically, the travel planning unit 23 searches the gateway information table 14 for a gateway that fulfills a given condition with respect to the ITO position read in Step S11.

The travel planning unit 23 searches for, for example, a gateway from which the ITO is reached by the shortest route. The definition of the shortest route is not particularly limited. For example, a route minimum in time, distance, or fare, or in the cost of one of time, distance, and fare, or in the cost of a combination of two or more of time, distance, and fare can be defined as the shortest route. An upper limit may be set to each cost.

The travel planning unit 23 can obtain route information about a route from the ITO position to the position of each gateway with the use of, for example, a Web API provided by an external information processing system. The travel planning unit 23 selects a gateway that has the shortest route out of the obtained routes. As a matter of course, the travel planning unit 23 may obtain, from the Web API, information regarding from which gateway the ITO position is reached by the shortest route.

This embodiment is easier to understand when airport is assumed as the type of gateways. As a matter of course, a gateway of other types, for example, a train station or a harbor, may be selected. The target user may be allowed to select a particular gateway type by operating the user terminal T.

The travel planning unit 23 then determines whether or not a gateway has successfully been obtained (Step S13). In the processing of Step S12, a gateway for the selected ITO cannot be obtained when, for example, routes to the ITO are unknown. The travel planning unit 23 in this case determines that a gateway cannot be obtained (that it is difficult to reach the ITO). Even when routes can be obtained, the travel planning unit 23 may determine that a gateway cannot be obtained in some cases, for example, a case in which the route information includes traveling by foot or a private car or other modes of transportation that are not a public transportation system, a case in which all seats are already reserved in a public transportation system that is included in the route information, and a case in which it is difficult for the user to reserve a seat by himself or herself in a public transportation system that is included in the route information.

When a gateway has failed to be obtained (Step S13: NO), the travel planning unit 23 searches for a tour (Step S14). Specifically, the travel planning unit 23 refers to the tour information table 12 to identify at least one tour in which the TO identifier 12f corresponding to the ITO identifier of the ITO that is selected in Step S11 is included as a schedule item, and reads the TO identifier 12a of each tour.

The travel planning unit 23 then adds each found tour as an ITO (Step S15). Specifically, the travel planning unit 23 adds a record of each ITO that is a tour to the candidate travel object table. The TO identifier 12a read in Step S14 is set as the ITO identifier of the added record. The ITO score of the ITO selected in Step S11, for example, is set as the ITO score of the added record. The travel planning unit 23 also deletes from the candidate travel object table a record of the ITO selected in Step S11. The travel planning unit 23 may delete from the candidate travel object table a record of the ITO selected in Step S11 when routes to the selected ITO are unknown, while retaining a record of the ITO selected in Step S11 in the candidate travel object table when routes to the selected ITO are successfully obtained.

The travel planning unit 23 then obtains a gateway for each added ITO (Step S16). Specifically, the travel planning unit 23 refers to the tour information table 12 to read the TO identifier 12f of a meeting place (in a schedule item for which “meeting up” is registered as the classification 12d) from schedule information of each tour added in Step S15. The travel planning unit 23 also refers to the travel object table 11 to read, as the position of the ITO, the position 11j that is associated with the TO identifier 11a corresponding to the read TO identifier. The travel planning unit 23 searches the gateway information table 14 for a gateway at a position that fulfills a given condition with respect to the read ITO position. The search is conducted by the same method that is used in Step S12. The travel planning unit 23 can obtain a gateway for an ITO that is a tour in this manner. The travel planning unit 23 may read the position of a breakup place as the position of the ITO instead of the position of a meeting place.

When a gateway is successfully obtained (Step S13: YES), or after Step S16, the travel planning unit 23 determines whether to end the operation of obtaining a gateway or not (Step S17). Specifically, the travel planning unit 23 determines that the operation of obtaining a gateway is to be ended (Step S17: YES) when every ITO copied to the candidate travel object table at the beginning of this flow chart has been selected, and ends the processing illustrated in the flow chart of FIG. 11. The travel planning unit 23 determines that the operation of obtaining a gateway is to be continued (Step S17: NO) when not every ITO has been selected, and returns the processing to Step S11. When a gateway is successfully obtained, the travel planning unit 23 increments the ITO count 14d by 1 in a record that corresponds to the gateway found in Step S12 or Step S16.

A higher ITO count means a higher gateway count (more combinations of an entry zone and an exit zone as well), which leads to an increase in number of travel plans that can be drawn up and an increase in computation processing load. The travel planning unit 23 may address this by executing the narrowing down of gateways when the operation of obtaining a gateway is to be ended. For example, the travel planning unit 23 extracts gateways that fulfill a given condition from all of the gateways obtained in Steps S11 to S17.

To give a specific example, the travel planning unit 23 can use an optional specified condition (the budget of the travel) specified by the user. The optional specified condition can be received from the user terminal T via the operation reception unit 22. More specifically, the travel planning unit 23 extracts gateways that require, for one-way travel from the user's departure base, a fare lower than the budget from the gateways obtained in Steps S11 to S17. The “departure base” of a user is, for example, an airport, a train station, a harbor, or a similar base of transportation that is nearest to the user's home. Information about the departure base, for example, position information and the name, can be registered in the storage unit 10 in advance. The travel planning unit 23 can use, for example, a Web API provided by an external information processing system to obtain, for each gateway, route information (including what mode of transportation is used and a fare of the mode of transportation) about a route from the position of the departure base to the position of the gateway. When the departure base and the gateway are both airports, for example, a fare for one-way flight between the airports can be obtained as route information. The travel planning unit 23 determines, for example, whether the proportion of the obtained one-way fare to the budget is equal to or less than a given value (e.g., 50% or less). The budget may be multiplied by a given coefficient.

The travel planning unit 23 extracts candidates for a gateway that can be used in a travel plan for the target user in the manner described above, and ends the processing illustrated in the flow chart of FIG. 11.

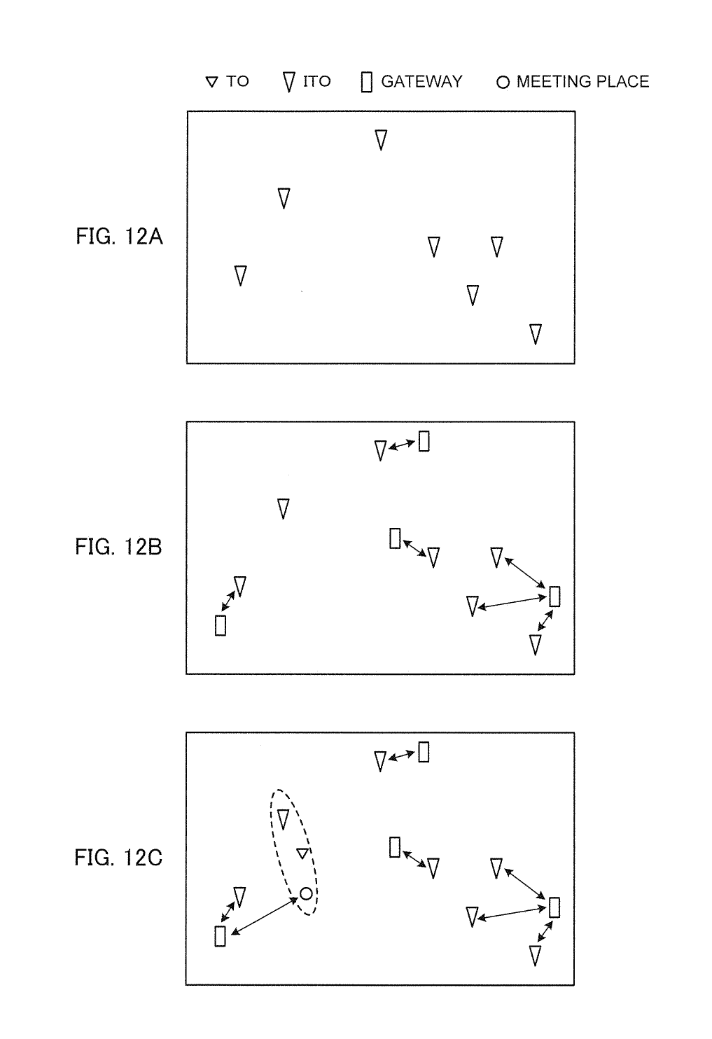

FIG. 12A to FIG. 12C are explanatory diagrams for illustrating an example of gateway obtaining processing in the embodiment.

A plurality of ITOs on a map are illustrated in FIG. 12A. Gateways obtained for the plurality of ITOs minus one ITO are illustrated in FIG. 12B. Each arrow beside one of the ITOs indicates a relation between the ITO and a gateway. A tour (a circle drawn in the broken line) that includes the ITO for which a gateway has failed to be obtained and a gateway obtained for a meeting place of the tour are illustrated in FIG. 12C. The tour includes the meeting place, TOs, and the ITO. The tour may additionally include a breakup place and other ITOs.

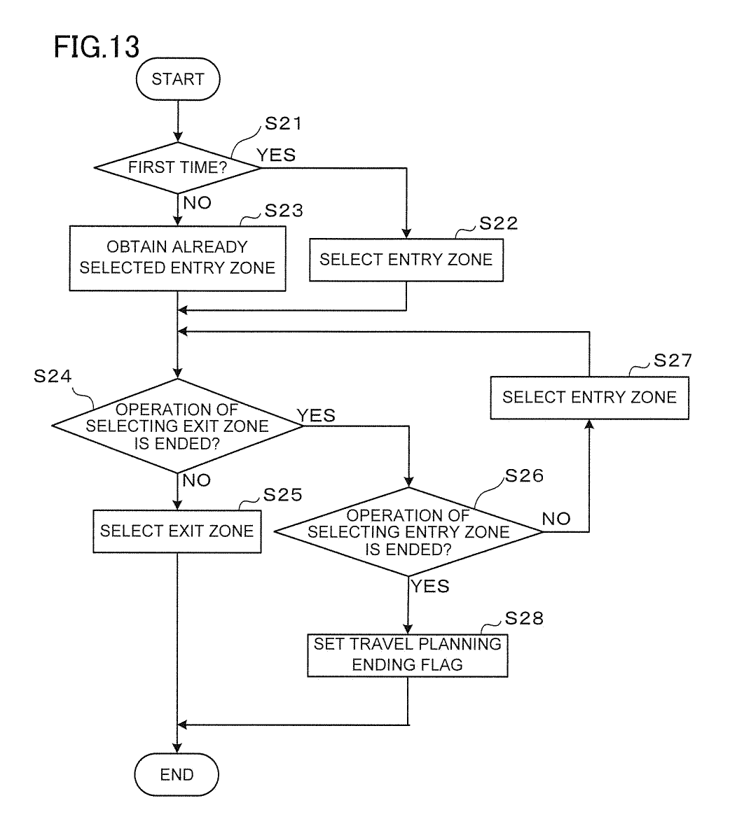

FIG. 13 is a flow chart for illustrating an example of the processing of Step S2 of FIG. 10.

The travel planning unit 23 first determines whether or not the processing of Step S2 is executed for the first time (Step S21).

When the processing of Step S2 is executed for the first time (Step S21: YES), the travel planning unit 23 selects an entry zone (Step S22). Specifically, the travel planning unit 23 selects as an entry zone one gateway out of the gateways extracted in Step S1. The order of selection is, for example, descending order of ITO count. The ITO count of each gateway can be obtained by referring to the ITO count 14d in the gateway information table 14.

When the processing of Step S2 is not executed for the first time (Step S21: NO), the travel planning unit 23 obtains the selected entry zone (Step S23). Specifically, the travel planning unit 23 selects an entry zone that has been selected in Step S22 or Step S27 last time.

After Step S22, Step S23, or Step S27, the travel planning unit 23 determines whether or not the operation of selecting an exit zone is to be ended (Step S24). The travel planning unit 23 determines that the operation of selecting an exit zone is to be continued (Step S24: NO) when an exit zone selection ending flag, which is described later, is not set, and advances the processing to Step S25. The travel planning unit 23 determines that the operation of selecting an exit zone is to be ended (Step S24: YES) when the exit zone selection ending flag is set, and advances the processing to Step S26.

When the operation of selecting an exit zone is to be continued, the travel planning unit 23 selects an exit zone (Step S25). Specifically, the travel planning unit 23 selects as an exit zone one gateway near the entry zone that has been selected in Step S22 or Step S27 last time. In this embodiment, the travel planning unit 23 selects, when focusing on one entry zone, the focus entry zone as an exit zone for the first time Step S25 is executed, and selects exit zones in descending order of nearness to the focus entry zone for the second and subsequent times Step S25 is executed. The travel planning unit 23 can select an exit zone by, for example, calculating the direct distance between the entry zone and the exit zone and making a choice based on the calculated distance. The travel planning unit 23 can use, for example, a Web API provided by an external information processing system to obtain, for each exit zone, the straight line from the position of the entry zone to the position of the exit zone. As a matter of course, the selection criterion used by the travel planning unit 23 is not limited to the direct distance between the entry zone and the exit zone, and the shortest route between the entry zone and the exit zone, for example, may be used instead.

When the operation of selecting an exit zone is to be ended, the travel planning unit 23 determines whether or not the operation of selecting an entry zone is to be ended (Step S26). Specifically, the travel planning unit 23 determines whether or not a given ending condition is fulfilled. The condition used by the travel planning unit 23 to determine that the operation of selecting an entry zone is to be ended is, for example, when every gateway extracted in Step S1 has been selected as an entry zone, when a given length of time has elapsed since the start of the travel planning processing, or when a given number of travel plans have been generated.

When the operation of selecting an entry zone is to be continued (Step S26: NO), the travel planning unit 23 selects an entry zone (Step S27). Specifically, the travel planning unit 23 selects as an entry zone one gateway from the unselected gateways out of the gateways that have been extracted in Step S1. The order of selection is the same as in Step S22. The travel planning unit 23 then returns the processing to Step S24.

When the operation of selecting an entry zone is to be ended (Step S26: YES), the travel planning unit 23 sets the travel planning ending flag (Step S28).

After the processing of Step S25 or Step S28, the travel planning unit 23 ends the processing illustrated in the flow chart of FIG. 13. The travel planning unit 23 can select a combination of an entry zone and an exit zone in this manner.

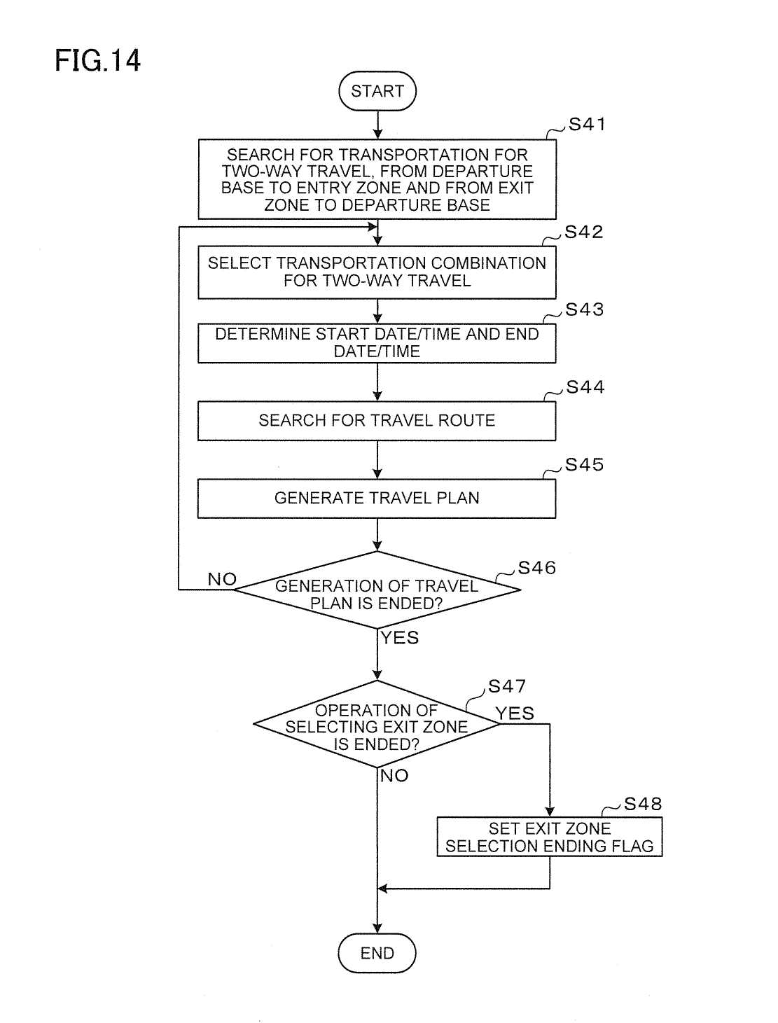

FIG. 14 is a flow chart for illustrating an example of the processing of Step S4 of FIG. 10.

The travel planning unit 23 first searches for modes of transportation for two-way travel, from the departure base to an entry zone and from an exit zone to the departure base (Step S41). Specifically, the travel planning unit 23 obtains the combination of an entry zone and an exit zone selected in Step S2. The travel planning unit 23 also searches for information about modes of transportation that leave the departure base and arrive at the entry zone in the travel time frame specified by the target user, and information about modes of transportation that leave the exit zone and arrive at the departure base in the specified travel time frame. When the departure base, the entry zone, and the exit zone are all airports, for example, information about two-way flight (including flight numbers, departure dates/times, arrival dates/times, and fares) is searched for. The travel planning unit 23 can use, for example, a Web API provided by an external information processing system to obtain information about modes of transportation. In this manner, the travel planning unit 23 can obtain information about at least one combination of transportation modes that fulfills the specified condition (travel time frame) of the target user for two-way travel, from the departure base to the entry zone and from the exit zone to the departure base. Information about each pair of transportation modes includes at least the date/time of arrival at the entry zone and the date/time of departure from the exit zone.

The travel planning unit 23 may obtain one combination of transportation modes that requires the lowest two-way fare from the at least one combination of transportation modes obtained in the manner described above as transportation for two-way travel, or may select a given number of combinations of transportation modes in ascending order from the lowest fare out of the at least one combination obtained. The travel planning unit 23 may also obtain, by using the optional specified condition (the budget of the travel) specified by the target user, at least one combination of transportation modes that requires a two-way fare within the budget from the at least one combination of transportation modes obtained in the manner described above as transportation for two-way travel.

The travel planning unit 23 then selects a combination of transportation modes for two-way travel (Step S42). Specifically, the travel planning unit 23 selects one combination out of the at least one combination of transportation modes obtained in Step S41 as transportation for two-way travel.

The travel planning unit 23 then determines a start date/time and an end date/time (Step S43). In the flow chart of FIG. 14, a travel route having the entry zone as the start point and the exit zone as the end point is generated. The “start date/time” is a date/time at which departure from the start point takes place. The “end date/time” is a date/time at which arrival at the end point takes place. Specifically, the travel planning unit 23 can use information about the transportation modes selected in Step S42 as transportation for two-way travel to set the date/time of arrival at the entry zone as the start date/time and the date/time of departure from the exit zone as the end date/time. As a matter of course, the start time/date is not limited to the date/time of arrival at the entry zone, and may be set to, for example, a date/time calculated by adding a given length of time (e.g., an hour) to the date/time of arrival at the entry zone. The end date/time is not limited to the date/time of departure from the exit zone, and may be set to, for example, a date/time calculated by subtracting a given length of time (e.g., two hours) from the date/time of departure from the exit zone.

The travel planning unit 23 then searches for a travel route (Step S44). In Step S44, the travel planning unit 23 searches for a travel route from the start point to the end point along which at least one ITO stored in the candidate travel object table is visited. The travel planning unit 23 also searches for a travel route that is highest in evaluation value based on the ITO score of the at least one ITO included in the travel route. The evaluation value is not limited to a particular definition, and can be, for example, the sum of the respective ITO scores of included ITOs or a value that is calculated by multiplying the sum by a given coefficient.

The travel route search can be implemented with the use of a general route search algorithm for solving a route optimization with time constraints, for example, a genetic algorithm, Dijkstra's algorithm, or Markov chain Monte Carlo. A detailed description on the route search algorithm itself is therefore omitted.

In this embodiment, the travel planning unit 23 searches for a travel route that overcomes time constraints and maximizes the evaluation value described above. One of the time constraints is that the route can be traveled in a time frame from the start date/time to end date/time determined in Step S43. Another time constraint is, for example, that each ITO along the route can be visited during its business hours and can accommodate the user at least as long as the recommended-time-to-spend. The business hours of each ITO can be obtained by referring to the start time 11g and the end time 11h in the travel object table 11. The recommended-time-to-spend of each ITO can be obtained by referring to the recommended-time-to-spend 11i in the travel object table 11.

In the travel route search, the travel planning unit 23 searches for a plurality of routes for travel between two points, for example, a route from the start point to an ITO, a route from the ITO to another ITO, and a route from some ITO to the end point. A meeting place or a breakup place in a tour can be used as one of the two points in the case of ITOs in a tour. The travel planning unit 23 can use, for example, a Web API provided by an external information processing system to obtain information about a route for travel between points (including, for example, the type of transportation, a departure date/time, an arrival date/time, a travel time, and a fare). Taxis and traveling on foot can be included as transportation modes in addition to airplanes, railways, ships, and automobiles. When information about the fare for travel between two points cannot be obtained, the fare can be calculated by following a given rule, for example, multiplying the distance between the two points by a given per-unit distance fare. The name and position information of each point can be obtained by referring to the travel object table 11. The meeting place of a tour can be obtained by referring to the tour information table 12.

In the travel route search, the travel planning unit 23 also takes into account time slots necessary in a general travel (for example, time slots for lodging, dining, and free time), and incorporates relevant ITOs in a travel route. For example, when the numbers of lodging-related ITOs and dining-related ITOs included in the candidate travel object table are less than given counts (e.g., a lodging count and dining count suitable for the number of days of travel), the travel planning unit 23 adds as many prepared TOs that represent lodging and dining time slots as necessary to make up the shortage to the candidate travel object table as ITOs. The travel planning unit 23 also adds, for example, a given number of (e.g., a count suitable for the number of days of travel) prepared TOs that represent free time zones to the candidate travel object table as ITOs. TOs representing necessary time zones for lodging, dining, free time, and the like can be obtained by referring to the travel object table 11. In the example of the travel object table 11 of FIG. 2, a TO representing a dining time slot (and having a TO identifier “99900001”), a TO representing a lodging time slot (and having a TO identifier “99900004”), and a TO representing a free time slot (and having a TO identifier “99990001”) are stored in advance. The travel planning unit 23 searches for a route in which ITOs of the necessary time slots are incorporated.

The candidate travel object table in this embodiment includes an ITO that is a tour in some cases (a case in which a tour is registered as an ITO of the target user in advance, or a case in which a tour is added in Step S15 of FIG. 11). Examples of possible consequences are a case in which, when a travel route includes a tourist attraction A and a tour A, the tourist attraction A is redundantly included in the tour A as well, and a case in which, when a travel route includes a tour A and a tour B, the tourist attraction A is redundantly included in the tour A and the tour B both. The travel planning unit 23 therefore searches for a travel route in which duplicate ITOs are eliminated.

A method that can be used for the deduplication of an ITO in a route search algorithm is, for example, putting an exclusion constraint between duplicate ITOs. For example, before conducting a route search, the travel planning unit 23 checks for duplication for each ITO stored in the candidate travel object table (duplication between an ITO that is a visiting place and a TO incorporated in the schedule of an ITO that is a tour, and duplication between a TO incorporated in the schedule of an ITO that is a tour and a TO incorporated in the schedule of another ITO that is a tour), and puts exclusion constraints between duplicate ITOs. The travel planning unit 23 searches for a travel route that has overcome the exclusion constraints.

In Markov chain Monte Carlo, a genetic algorithm, and other similar route search algorithms, for example, the travel planning unit 23 sets the lowest evaluation value to a solution that fails to overcome the exclusion constraints, or turns the solution into a lethal gene. This prevents a travel route that has the lowest evaluation value from being selected. In Dijkstra's algorithm and other similar route search algorithms, an ITO (a visiting place or a tour) having an exclusive relationship with an ITO (a visiting place or a tour) that is already included in a route is prohibited from being added to the route. This prevents a travel route that includes duplicate ITOs from being retrieved.

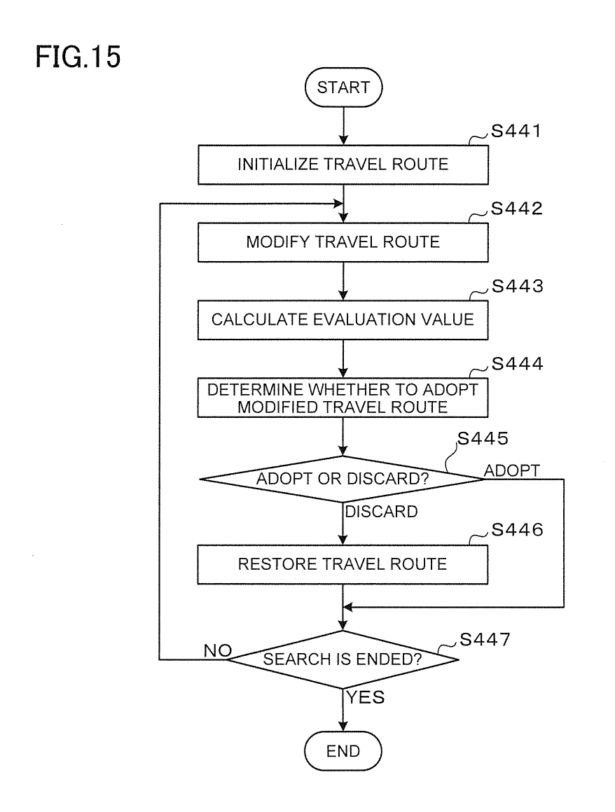

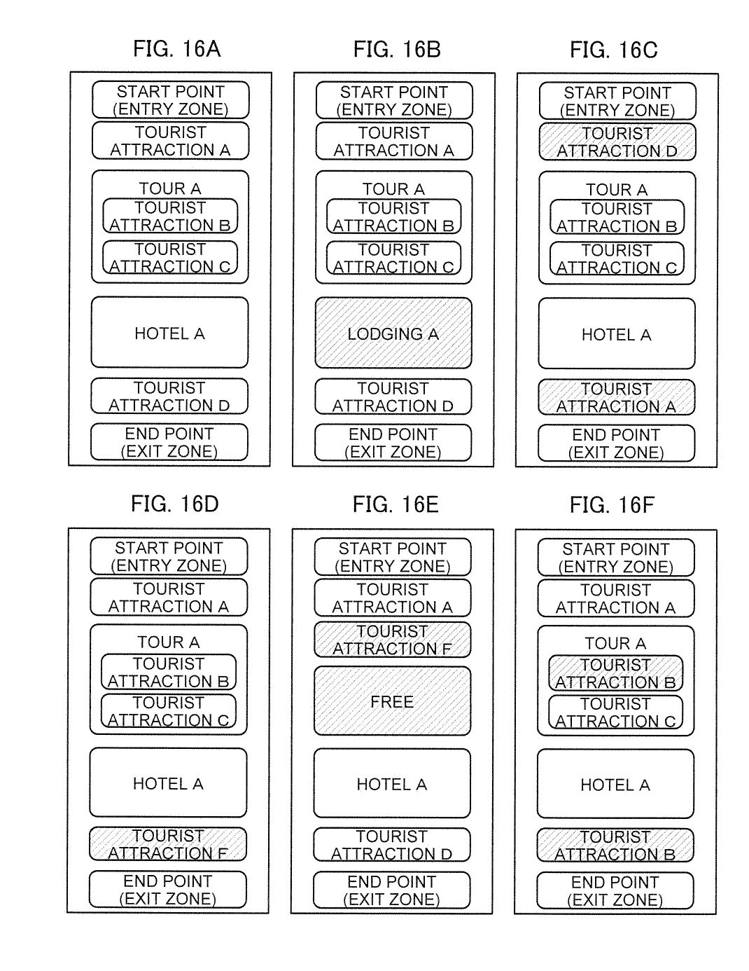

The travel planning unit 23 can search for a travel route from the start point to the end point along which at least one ITO is visited in the manner described above. An example of the travel route search processing is described later with reference to FIG. 15 and FIG. 16A to FIG. 16F.

The travel planning unit 23 then generates a travel plan (Step S45). Specifically, the travel planning unit 23 generates travel plan information that corresponds to the travel route found in Step S44, and stores the travel plan information in the travel plan table 15 in association with the user identifier of the target user. The number of ITOs to be visited along the found travel route is set to the visited ITO count 15c. A cost set to the cost and time frame 15d is, for example, the sum of the cost of travel from the start point to the end point, the cost of travel from the departure base to the start point, and the cost of travel from the end point to the departure base. A time frame from the departure from the departure base to the return to the departure base, for example, is set to the cost and time frame 15d. The evaluation value of the found travel route is set to the evaluation value 15e. Schedule data of the found travel route, for example, data for displaying a timetable as the one illustrated in FIG. 19, is set to the detailed schedule 15f. The detailed schedule 15f includes, for example, information about the departure base, the date/time of departure from the departure base, information about the start point (entry zone), the date/time of arrival at the start point, the date/time of departure from the start point, information about each ITO to be visited and a time slot for the visit to the ITO, necessary time slots for lodging, dining, free time, and the like, the date/time of arrival at the end point (exit zone), and the date/time of departure from the end point.

There are cases in which no travel route is found as a result of executing Step S44, for example, a case in which there is no route that can be traveled to reach the end point from the start point within the time frame specified by the target user. The travel planning unit 23 in this case does not generate a travel plan in Step S45.

The travel planning unit 23 then determines whether or not the generation of a travel plan is to be ended (Step S46). Specifically, the travel planning unit 23 determines whether a given ending condition is fulfilled. The condition used by the travel planning unit 23 to determine that the generation of a travel plan is to be ended is, for example, when every combination of transportation modes for two-way travel has been selected in Step S42, when a travel plan whose evaluation value exceeds a given value is successfully generated, or when a given length of time has elapsed since the start of the processing of this flow chart.

When the generation of a travel plan is to be continued (Step S46: NO), the travel planning unit 23 returns the processing to Step S42. In Step S42, the travel planning unit 23 selects one combination of transportation modes out of combinations of transportation modes for two-way travel that have not been selected yet.

When the generation of a travel plan is to be ended (Step S46: YES), the travel planning unit 23 determines whether or not the operation of selecting an exit zone is to be ended (Step S47). Specifically, the travel planning unit 23 determines whether a given ending condition is fulfilled. The condition used by the travel planning unit 23 to determine that the operation of selecting an exit zone is to be ended is, for example, when no travel plan has successfully been generated in Step S45. The travel planning unit 23 may use the optional specified condition (the budget of the travel) of the target user to determine that the operation of selecting an exit zone is to be ended when the cost of each travel plan generated in Step S45 is over the budget.

When the operation of selecting an exit zone is to be ended (Step S47: YES), the travel planning unit 23 sets the exit zone selection ending flag (Step S48). When the operation of selecting an exit zone is not to be ended (Step S47: NO), or after Step S48, the travel planning unit 23 ends the processing illustrated in the flow chart of FIG. 14.

FIG. 15 is a flow chart for illustrating an example of the processing of Step S44 of FIG. 14. In FIG. 15, the outline of processing that is executed when Markov chain Monte Carlo is used as a route search algorithm is illustrated. FIG. 16A to FIG. 16F are explanatory diagrams for illustrating an example of the travel route search processing in the embodiment. Images of a travel route in FIG. 16A to FIG. 16F are simplified for description.

The travel planning unit 23 first initializes a travel route (Step S441). Specifically, the travel planning unit 23 determines a travel route from the start point to the end point that overcomes the time constraints described above. The travel planning unit 23 selects at least one ITO stored in the candidate travel object table, and inserts the selected ITO to the travel route. The number and order of ITOs inserted to the travel route are arbitrary and can be determined at random, for example. The travel planning unit 23 also determines, for each pair of points, a route for travel between the pair of points. The travel planning unit 23 may insert a necessary time slot or necessary time slots between each pair of points. The travel planning unit 23 calculates the evaluation value of the determined initial travel route. The evaluation value is calculated by the same method that is used in Step S443.

An example of the initial travel route is illustrated in FIG. 16A. An ITO “hotel A”, which is a lodging place, is inserted to the initial travel route in addition to an ITO that is a tourist attraction and an ITO that is a tour. Another example of the initial travel route is illustrated in FIG. 16B. An ITO “lodging A” of a necessary time slot (lodging) is inserted to the initial travel route when an ITO of a necessary time slot (lodging) has not been registered.

The travel planning unit 23 then modifies a travel route (Step S442). Specifically, the travel planning unit 23 modifies a target travel route (the initial travel route determined in Step S441, or a modified travel route that has been determined in Step S442 last time, or a modified travel route that has been restored in Step S446). The method of modification of the travel route is not particularly limited. For example, the travel planning unit 23 switches the places of two ITOs that are selected at random out of ITOs arranged along the target travel route. Alternatively, the travel planning unit 23 exchanges one ITO that is selected at random out of ITOs arranged along the target travel route for one ITO that is selected at random from the candidate travel object table. The travel planning unit 23 may instead insert one ITO that is selected at random from the candidate travel object table to the target travel route. The travel planning unit 23 determines in Step S442 a modified travel route without consideration for the time constraints described above. The travel planning unit 23 also determines, for each pair of points, a route for travel between the pair of points.

An example of the modified travel route that is a modification of the travel route of FIG. 16A is illustrated in FIG. 16C. In this modified travel route, the places of an ITO “tourist attraction A” and an ITO “tourist attraction D” are switched. Another example of the modified travel route that is a modification of the travel route of FIG. 16A is illustrated in FIG. 16D. In this modified travel route, an ITO “tourist attraction F” is inserted in place of the ITO “tourist attraction D”. Still another example of the modified travel route that is a modification of the travel route of FIG. 16A is illustrated in FIG. 16E. In this modified travel route, the ITO “tourist attraction F” is inserted in place of an ITO “tour A”, and an ITO “free”, which is a free time, is inserted in a slot following the ITO “tourist attraction F”. Yet another example of the modified travel route that is a modification of the travel route of FIG. 16A is illustrated in FIG. 16F. In this modified travel route, an ITO “tourist attraction B” is inserted in place of the ITO “tourist attraction D”. The inserted ITO “tourist attraction B” is a duplicate of the “tourist attraction B” that is included in the ITO “tour A”.

The travel planning unit 23 then calculates the evaluation value (Step S443). Specifically, the travel planning unit 23 calculates the evaluation value of the modified travel route that has been determined in Step S443. As the evaluation value, the travel planning unit 23 calculates, for example, the sum (a positive value) of the respective ITO scores of ITOs included in the modified travel route. The travel planning unit 23, however, sets the lowest value (e.g., a given value that represents minus ∞) when the modified travel route falls under given conditions, for example, when the modified travel route fails to overcome the time constraints described above, and when the modified travel route includes duplicate ITOs (e.g., the case of FIG. 16F).

The travel planning unit 23 then determines whether or not the modified travel route is to be adopted (Step S444). Specifically, the travel planning unit 23 determines whether to adopt the modified travel route based on the evaluation value of the target travel route (pre-modification travel route) in Step S442 and the evaluation value of the modified travel route (post-modification travel route) determined in Step S442. To give a specific example, the modified travel route is adopted at the following adoption probability P:

P(ΔE)=e^{-ΔEB}

In the expression, ΔE represents a differential value that is a difference between the evaluation values of the pre-modification travel route and the post-modification travel route, P(ΔE) represents the adoption probability, and B represents an adoption probability adjustment parameter.

In this example, the modified travel route that is improved in evaluation value is adopted at 100%, and even the modified travel route that is lowered in evaluation value is adopted at a probability depending on the degree of being lowered. The adoption probability can be adjusted with the use of the parameter B.

The travel planning unit 23 then determines whether the modified travel plan is to be adopted or discarded, based on the result of the determination in Step S444 (Step S445). When the modified travel route is to be adopted (Step S445: adopt), the travel planning unit 23 advances the processing to Step S447. When the modified travel route is to be discarded (Step S445: discard), the travel planning unit 23 restores the modified travel route to the target travel route in Step S442 (the pre-modification travel route) (Step S446), and advances the processing to Step S447.

The travel planning unit 23 then determines whether or not the search is to be ended (Step S447). Specifically, the travel planning unit 23 determines whether a given ending condition is fulfilled. The condition used by the travel planning unit 23 to determine that the search is to be ended is, for example, when the number of times Step S442 has been executed exceeds a given count, or when a travel route whose evaluation value exceeds a given value has successfully been found.

When the search is to be continued (Step S447: NO), the travel planning unit 23 returns the processing to Step S442. When the search is to be ended (Step S447: YES), the travel planning unit 23 ends the processing illustrated in the flow chart of FIG. 15.

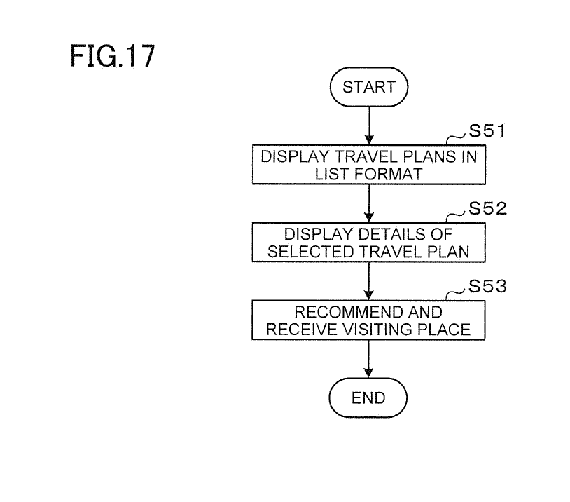

FIG. 17 is a flow chart for illustrating an example of the processing of Step S5 of FIG. 10.

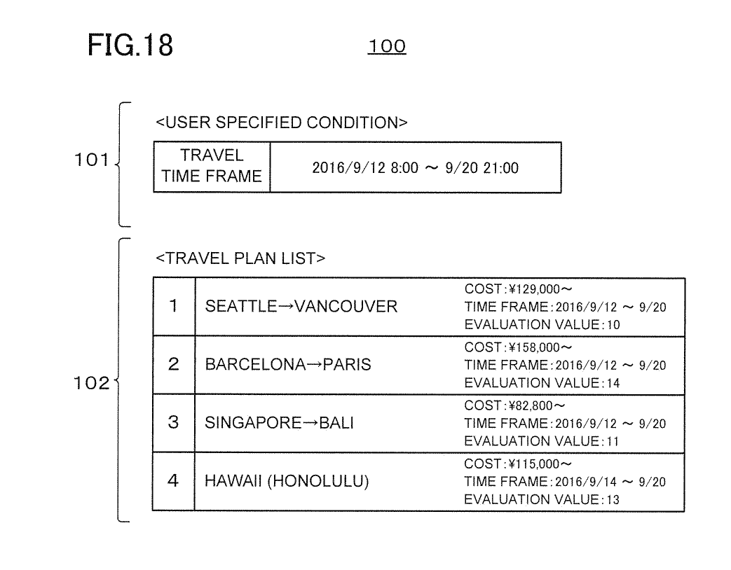

The travel planning unit 23 first displays a list of travel plans (Step S51). Specifically, the travel planning unit 23 uses each piece of travel plan information stored for the target user in the travel plan table 15 to generate a Web page displayed as illustrated in, for example, FIG. 18, and transmits the generated Web page to the user terminal T via the operation reception unit 22. The user terminal T receives the Web page and displays a Web screen.

FIG. 18 is a diagram for illustrating an example of a screen on which a list of travel plans is displayed in the embodiment. A Web screen 100 includes an area 101 in which a specified condition (the time frame of the travel) of the user is displayed, and an area 102 in which a list of generated travel plans is displayed. The name of an entry zone, or the names of an entry zone and an exit zone, the cost, the time frame, and the evaluation value are displayed for each travel plan in the area 102 so that the outline of the travel plan can be understood. A detailed timetable of a travel plan can be displayed by selecting one of the travel plans displayed in the area 102.

The travel planning unit 23 then displays details of the selected travel plan (Step S52). For example, when the user's operation to select one of the travel plans in the area 102 of the Web screen 100 is received via the operation reception unit 22, the travel planning unit 23 uses travel plan information of the selected travel plan to generate a Web page displayed as illustrated in, for example, FIG. 19. The travel planning unit 23 transmits the generated Web page to the user terminal T via the operation reception unit 22.

FIG. 19 is a diagram for illustrating an example of the screen on which the timetable of a travel plan is displayed in the embodiment. A Web screen 200 is configured so as to align timetables each spanning one day (24 hours) in the lateral direction. Four days of timetables are illustrated in FIG. 19. Box areas corresponding to the departure base, the entry zone, the exit zone, and ITOs (e.g., tourist attractions, sightseeing tours, eateries, and shopping places), ITOs (necessary time slots), and others that are included in the travel plan are arranged on the timetables. The top side and bottom side of each box area indicate the start date/time and end date/time of a time slot represented by the box area.

Box areas of necessary time slots for lodging, dining, free time, and the like may be displayed in a mode distinguishable from other box areas so that the user can instinctively understand that a visiting place is not set yet. In FIG. 19, box areas of necessary time slots are displayed in an enhanced manner with the use of a “?” mark. Box areas of sightseeing tours may be displayed in a mode distinguishable from other box areas so that the user can instinctively understand that the box areas represent sightseeing tours. In FIG. 19, box areas of sightseeing tours are displayed in an enhanced manner with the use of a “T” mark. Box areas of dining (including box areas of necessary time slots) may be displayed in a mode distinguishable from other box areas so that the user can instinctively understand that the box areas represent meal times. In FIG. 19, box areas of dining are displayed in an enhanced manner with the use of a “D” mark. Box areas of lodging (including box areas of necessary time slots) may be displayed in a mode distinguishable from other box areas so that the user can instinctively understand that the box areas represent lodging times. In FIG. 19, box areas of lodging are displayed in an enhanced manner with the use of an “H” mark.

The Web screen 200 may be configured so that, for each box area displayed on the timetables, details of a visiting place associated with the box area are displayed by selecting the box area. When the box area of a hotel is selected, for example, detailed information of this hotel is displayed. When the box area of a tour is selected, for example, the schedule of this tour is displayed. When the box area of a necessary time slot is selected, for example, a list of visiting places recommended to be inserted to this time slot is displayed.

The travel planning unit 23 then recommends a visiting place and receives a visiting place (Step S52). When receiving the operation of selecting the box area of one of necessary time slots in a timetable on the Web screen 200, for example, the travel planning unit 23 displays a list of visiting places that fulfill a given condition for being inserted to the necessary time slot. To give a specific example, the travel planning unit 23 refers to the travel object table 11, uses the position 11j associated with the selected necessary time slot and the positions 11j of other TOs to search for TOs (tourist attractions, eateries, and the like) that are within a given distance from the position associated with the selected necessary time slot, and displays a list of the found TOs. To give another specific example, the travel planning unit 23 refers to the travel object table 11, searches for TOs that belong to the same classification as the classification 11c of the selected necessary time zone and that are within a given distance from the position associated with the necessary time slot, and displays a list of the found TOs.

In another example, when receiving the operation of selecting the box area of one of necessary time slots, the travel planning unit 23 determines whether or not every ITO included in the travel plan fulfills a first condition. When not every ITO fulfills the first condition, the travel planning unit 23 displays a list of visiting places that fulfill a second condition for being inserted to the necessary time slot. To give a specific example, the travel planning unit 23 determines, for each ITO included in the travel plan, whether or not the ITO is related to “souvenir” (the first condition) by referring to the tag 11d of the ITO through reference to the travel object table 11. When the travel plan does not include an ITO related to “souvenir”, the travel planning unit 23 refers to the travel object table 11 to search for TOs that are within a given distance from the position associated with the selected necessary time slot and that are related to “souvenir” (the second condition), and displays a list of found TOs.

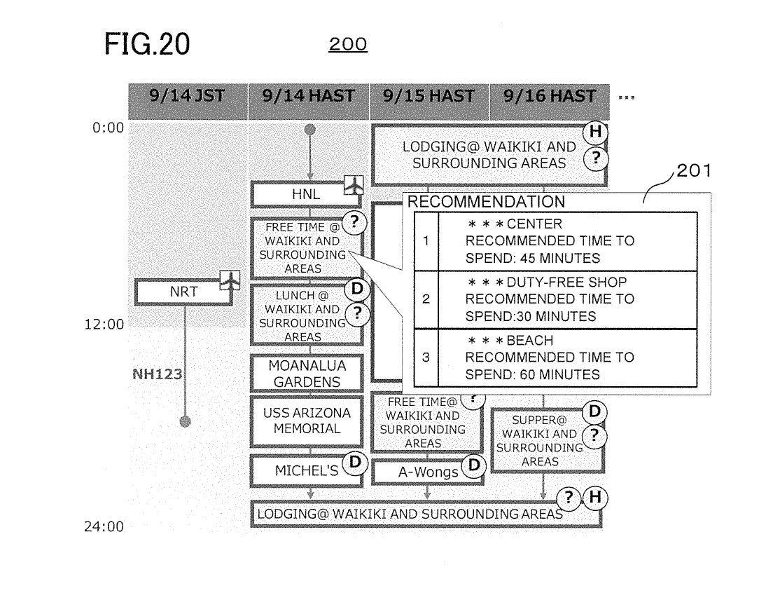

FIG. 20 is a diagram for illustrating another example of the screen on which the timetable of a travel plan is displayed in the embodiment. The case illustrated in FIG. 20 is a case in which a box area (“free time @ Waikiki and surrounding areas”) is selected on the Web screen 200 of FIG. 19. A list 201 of visiting places that are recommended to be inserted to the selected box area is displayed overlaid on the Web screen 200.

When the selection of one of the visiting places from the visiting place list is received, the travel planning unit 23 attempts to insert (set) the selected visiting place to the time slot of the currently selected box area. Specifically, the travel planning unit 23 determines, as a modified travel route, the travel route modified by the insertion of the visiting place, without consideration to the time constraints described above, and determines, for each pair of points, a route for travel between the pair of points. The travel planning unit 23 also determines whether the modified travel route overcomes the time constraints described above. When the modified travel route fails to overcome the time constraints, the travel planning unit 23 displays, for example, a message to the effect that the selected visiting place cannot be inserted. When the modified travel route overcomes the time constraints, the travel planning unit 23 updates the travel plan information of the selected travel plan.

When the selected visiting place is determined as difficult to access because travel routes to the selected visiting place are unknown or for other reasons, the travel planning unit 23 displays a message or the like to the effect that the selected visiting place is difficult to access. The travel planning unit 23 may identify a sightseeing tour that includes the selected visiting place when the selecting visiting place is difficult to access, and may display a list of at least one identified sightseeing tour. When the selection of one of the sightseeing tours from the list of sightseeing tours is received, the travel planning unit 23 attempts to insert the selected sightseeing tour to the time slot of the currently selected box area. Specifically, the travel planning unit 23 determines, as a modified travel route, the travel route modified by the insertion of the sightseeing tour, without consideration to the time constraints described above, and determines, for each pair of points, a route for travel between the pair of points. The travel planning unit 23 also determines whether the modified travel route overcomes the time constraints described above. When the modified travel route fails to overcome the time constraints, the travel planning unit 23 may display, for example, a message to the effect that the selected sightseeing tour cannot be inserted. When the modified travel route overcomes the time constraints, the travel planning unit 23 updates the travel plan information of the selected travel plan. The travel planning unit 23 may check for duplication between TOs included in the schedule of the inserted sightseeing tour and TOs incorporated in the travel plan. When there is duplication, the travel planning unit 23 may display, for example, a message to the effect that the selected sightseeing tour cannot be inserted. When there is no duplication, the travel planning unit 23 updates the travel plan information of the selected travel plan.

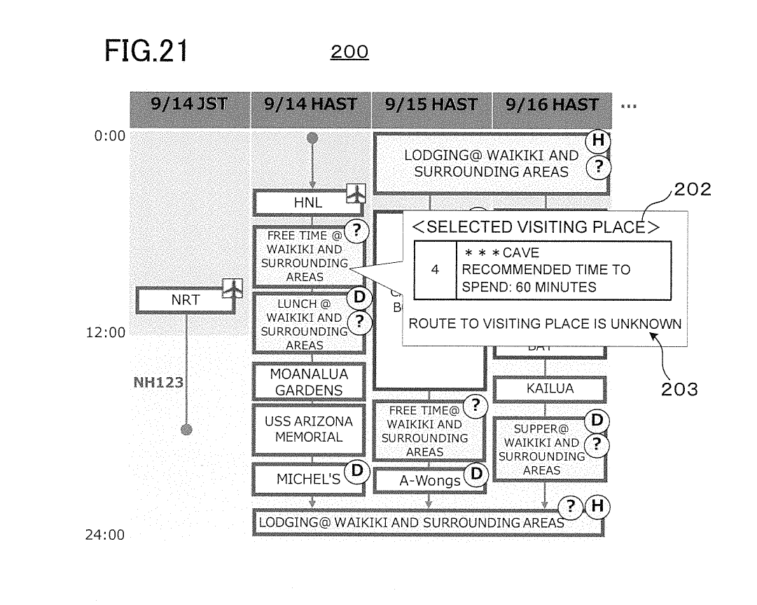

FIG. 21 is a diagram for illustrating still another example of the screen on which the timetable of a travel plan is displayed in the embodiment. The case illustrated in FIG. 21 is a case in which one visiting place on the list 201 of FIG. 20 is selected and inserted to the box area (“free time @ Waikiki and surrounding areas”) on the Web screen 200, and travel routes to the selected visiting place are unknown. A selected visiting place 202 and a message 203 to the effect that routes to the visiting place are unknown are displayed overlaid on the Web screen 200.

This concludes the description on one embodiment of the present invention. According to this embodiment, a travel plan in which a visiting place of a traveler's interest is incorporated can be drawn up.

For example, the travel planning system 1 according to this embodiment receives the registration of an interested visiting place from a user. The travel planning system 1 also receives a specified condition (the time frame of the travel) specified by the user. The travel planning system 1 then draws up a travel plan for a travel within the specified time frame in which at least one interested visiting place that has been registered is included. In travel planning processing, the travel planning system 1 obtains a gateway for each interested visiting place, determines a combination of an entry zone and an exit zone from the obtained gateways, and generates a travel plan for a travel from the entry zone to the exit zone in which at least one interested visiting place is included. The travel planning system 1 can efficiently draw up a travel plan in which an interested visiting place is included in this manner.

For example, the travel planning system 1 can receive the registration of a tour in which at least one place is visited, as an interested visiting place. In the travel planning processing, the travel planning system 1 generates a travel plan for a travel from the entry zone to the exit zone in which at least one interested visiting place (a tour is counted as a visiting place) is included. The travel planning system 1 can efficiently draw up a travel plan in which a sightseeing tour is included as well as a single visiting place, for example, a tourist attraction, in this manner.

For example, when an interested visiting place is difficult to access, the travel planning system 1 obtains a tour in which this interested visiting place is visited, and generates a travel plan for a travel from the entry zone to the exit zone in which at least one interested visiting place (a tour is counted as an interested visiting place) is included. The travel planning system 1 can efficiently draw up a travel plan in which an interested visiting place that is difficult to access can be visited in this manner.

For example, the travel planning system 1 generates a travel plan from which duplication between an interested visiting place that is a single visiting place and a visiting place that is included in a tour is eliminated. The travel planning system 1 can avoid drawing up a travel plan in which the same visiting place is redundantly passed through a plurality of times in this manner.

For example, the travel planning system 1 calculates the evaluation value of a travel plan in travel route search processing with the use of a score given by the user to each interested visiting place, and generates a travel plan that has a higher evaluation value. The travel planning system 1 can draw up a travel plan that improves the degree of satisfaction of the user by taking the quality and number of interested visiting places into consideration in this manner.

The present invention is not limited to the embodiment described above, and can be carried out in various modified manners without departing from the spirit of the present invention. The embodiment may be combined with one or more of modification examples.

The travel planning system 1 according to the embodiment draws up a travel plan for one user. In a modification example, the travel planning system 1 may draw up a travel plan for a group to which a plurality of users belong.

Specifically, the travel planning unit 23 generates a candidate travel object table for the group, and copies interested travel objects of users who belong to the same group to the candidate travel object table. The same interested travel object of a plurality of users is consolidated into one record. The ITO score of the consolidated interested travel object is calculated by, for example, adding up ITO scores given by the plurality of users. The sum of the ITO scores may be multiplied by a given coefficient. The travel planning unit 23 then executes the travel planning processing illustrated in FIG. 10 with the use of interested travel objects registered for the group in the candidate travel object table. The travel planning unit 23 receives a specified condition (the time frame of the travel) specified by the group, and uses the specified condition in the execution of the travel planning processing.

In this modification example, a high score is given to an interested visiting place common to a plurality of users, and the travel planning system 1 can accordingly generate a travel plan in which more interested visiting places common to a plurality of users are incorporated.

The travel planning system 1 according to the embodiment draws up a travel plan by using pre-registered ITOs of a target user. In another modification example, a target user may be allowed to select at least one ITO. Specifically, the travel planning unit 23 receives from the target user the selection of at least one ITO selected from the interested travel object table 13 when starting to draw up a travel plan. The travel planning unit 23 then searches for a travel route along which at least each selected ITO is visited. The travel planning unit 23 may search for a travel route that has a gateway of a selected ITO as the start point or the end point. This enables the travel planning unit 23 to draw up a travel plan on which a user's wish is reflected more accurately.

The travel planning unit 23 in the embodiment registers pre-registered ITOs of a target user to the candidate travel object table. In the case of an ITO difficult to access, the travel planning system 1 adds TOs of a related tour to the candidate travel object table as ITOs. In still another modification example, when the number of ITOs registered for a target user in advance is equal to or less than a given count (e.g., three or less), the travel planning unit 23 may add, for each ITO, TOs related to the ITO to the candidate travel object table as ITOs. The travel planning unit 23 extracts, for each ITO, at least one TO that is, for example, within a given distance from the position of the ITO serving as a reference, or at least one TO that is assigned the same region code as the ITO, from the travel object table 11, and adds the extracted TOs to the candidate travel object table as ITOs. A value smaller than (e.g., 0.5 time) the ITO score of the ITO serving as a reference, for example, is set as the score of the added ITO. In this manner, a travel plan meaningful to a target user can be generated even when the number of ITOs registered for the target user in advance is small.

The travel planning unit 23 in the embodiment receives an instruction to insert a selected visiting place to a necessary time slot selected in a timetable, and searches fora travel route modified by the insertion of the selected visiting place (see FIG. 20). In yet another modification example, the travel planning unit 23 may receive from the user an instruction to change the start date/time (or end date/time) of a box area in a timetable. The travel planning unit 23 may also receive from the user an instruction to add a box area corresponding to an ITO that is a necessary time slot, a visiting place, or the like in a timetable (the instruction contains a position at which the time slot is added, and the start date/time and end date/time of the time slot). The travel planning unit 23 may also receive from the user an instruction to remove a box area from a timetable.

When the editing operation described above (the insertion of a visiting place to a box area, a change to the start date/time and end date/time of a box area, the addition of a box area, or the removal of a box area) is received, the travel planning unit 23 may re-execute travel route search. Specifically, the travel planning unit 23 determines a travel route modified by the above-mentioned editing operation as the initial travel route, without consideration to the time constraints described above. The travel planning unit 23 then searches for a travel route by the method of Steps S442 to S447 of FIG. 15. In Step S442, however, the only modification method is to switch the places of two ITOs randomly selected out of ITOs that are arranged along the target travel route. The travel planning unit 23 generates travel plan information corresponding to the found travel route, and displays the timetable of this travel plan.

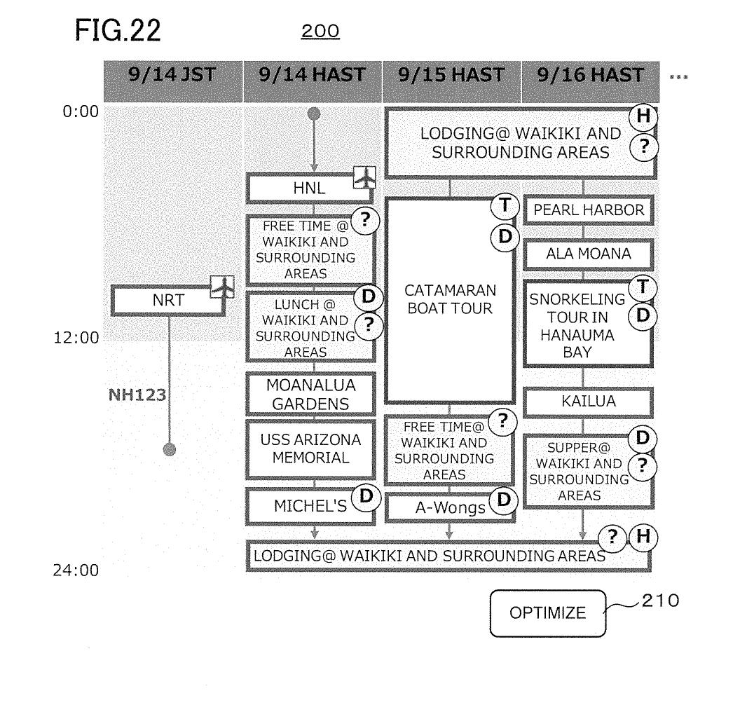

The Web screen 200 may be provided with a button for issuing an instruction to re-execute travel route search (an optimization button 210) as illustrated in FIG. 22. The travel planning unit 23 re-executes travel route search when the operation of the optimization button 210 is received.

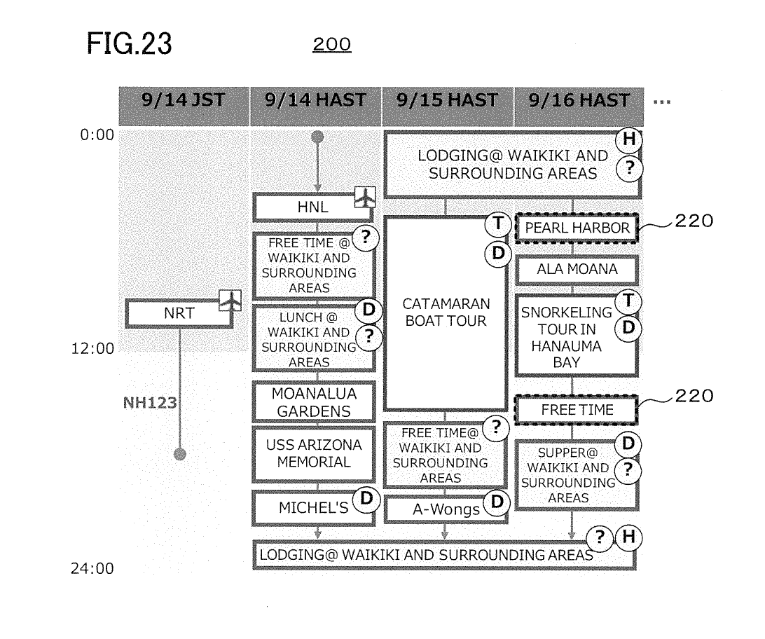

The travel planning unit 23 may receive, in addition to the editing operation described above, the selection of at least one box area out of box areas (including added box areas) arranged in a timetable, and may receive settings for prohibiting a change to the placement (i.e., start date/time and end date/time) of the at least one selected box area on the travel route. For example, box areas 220 prohibited to change their placement are enclosed by the broken lines in the timetable on the Web screen 200 as illustrated in FIG. 23. When the search for a travel route that includes an ITO prohibited to change its placement is re-executed, the travel planning unit 23 executes in Step S442 only the modification method in which two ITOs randomly selected out of ITOs that are arranged along the target travel route (except ITOs that are prohibited to change their placement) switch places. The prohibition of changing the placement, too, can be called as a constraint.

In the modification example described above, the travel planning system 1 can receive a modification to a travel plan displayed in a timetable. The travel planning system 1 can also optimize the modified travel plan so that time constraints are overcome. The travel planning system 1 is further capable of optimizing a travel plan that includes an ITO prohibited to change its placement while maintaining the placement of the ITO, that is, while fixing the date/time at which the ITO is visited.

In yet another modification example, the travel planning unit 23 in the embodiment may use, for example, a Web API provided by an external information processing system to execute processing of reserving a seat on a flight or other modes of transportation included in a travel plan generated for the target user, and reserving a room in a hotel or other similar facilities. This significantly reduces the user's burden related to reservation for realizing the travel plan.

The travel planning system 1 in the embodiment draws up a travel plan by utilizing an external information processing system. In yet another modification example, the travel planning system 1 may hold a map database, a database about transportation, and other databases to execute in the travel planning system 1 at least part of processing executed in the external information processing system.

The travel planning unit 23 in the embodiment employs a specified condition (the time frame of a travel) specified by a user as a constraint in travel route search processing. In yet another modification example, an optional specified condition (the budget of the travel) specified by the user may additionally be employed as a constraint. In this manner, a travel plan that can be realized within a travel time frame and travel budget specified by the user can be drawn up.

Components of the travel planning system 1 illustrated in FIG. 1 are sorted by the specifics of the main processing of the components in order to facilitate understanding of the configuration of the travel planning system 1. How the components are sorted or named does not limit the present invention. The components of the travel planning system 1 can be sorted into more pieces depending on the specifics of the processing. The components may be sorted so that a single component executes more processing procedures. Processing procedures of the components may be executed by a single piece of hardware, or by a plurality of pieces of hardware. How processing procedures or functions are assigned among the components is not limited to the one illustrated in FIG. 1 as long as the object and effects of the present invention are attained. The configurations of the tables are not limited to the examples illustrated in FIG. 2 to FIG. 8 as long as the object and effects of the present invention are attained.

Processing illustrated in the flow charts of FIG. 10, FIG. 11, FIG. 13 to FIG. 15, and FIG. 17 is broken into processing units based on the specifics of main processing, in order to facilitate understanding of the processing of the travel planning system 1. How the processing is broken into processing units and how the processing units are named does not limit the present invention. The processing of the travel planning system 1 may be broken into more processing units depending on the specifics of processing. The processing of the travel planning system 1 may be divided so that one processing unit includes more processing procedures. The order of processing steps of the flow charts is not limited to the illustrated examples as long as the object and effects of the present invention are attained.

The present invention is not limited to the embodiment described above and covers various modification examples. For instance, the embodiment described above is a detailed description written for an easy understanding of the present invention, and the present invention is not necessarily limited to a configuration that includes all of the described components. The configuration of one embodiment may partially be replaced by the configuration of another embodiment. The configuration of one embodiment may be joined by the configuration of another embodiment. In the embodiment, a part of the configuration of the embodiment may have another configuration added thereto or removed therefrom, or may be replaced by another configuration.

Some of or all of the configurations, functions, processing units, processing means, and the like described above may be implemented by hardware by, for example, designing those as an integrated circuit. The configurations, functions, and the like described above may be implemented by software through a processor's interpretation and execution of programs for implementing the respective functions. The programs for implementing the functions and information such as tables and files can be put in a memory, in a storage device such as a hard disk or a solid state drive (SSD), or in a recording medium such as an IC card, an SD card, or a DVD. Control lines or information lines considered necessary for description are illustrated, and not all control lines and information lines necessary for a product are necessarily illustrated. It may be considered that almost all configurations are actually mutually connected to each other.

The present invention can provide not only a travel planning system, but also various embodiments including a computer readable program executed by the travel planning system, a travel planning method, and the like.

1. A travel planning system, comprising:
a storage unit configured to store at least one interested travel object, each of the at least one interested travel object being information about an interested visiting place of a user and comprising position information of the interested visiting place;
a travel planning unit configured to generate a travel plan comprising a travel route, by using the position information of the at least one interested visiting place, which is indicated by the interested travel object, the travel route comprising at least one interested visiting place and being travelable within a specified time frame that is specified by the user; and
an operation reception unit configured to output the generated travel plan.

2. A travel planning system according to claim 1, further comprising a travel object collection unit configured to receive information about the interested visiting place from a user terminal of the user to store in the storage unit the interested travel object corresponding to the received information about the interested visiting place.

3. A travel planning system according to claim 1, wherein the travel planning unit is configured to:
obtain, for each interested visiting place, a gateway used to access the each interested visiting place;
select a combination of an entry zone of the travel route and an exit zone of the travel route out of the at least one obtained gateway; and
generate the travel route comprising the selected entry zone, the at least one interested visiting place, and the selected exit zone, and being travelable within the specified time frame.

4. A travel planning system according to claim 1,
wherein the at least one interested travel object is information about a tour, and comprises position information of a meeting place and position information of at least one visiting place, and
wherein the travel planning unit is configured to generate the travel route by using the position information of the interested visiting place and the position information of the meeting place, which are indicated by the at least one interested travel object, the travel route comprising at least one of: the at least one interested visiting place; or the at least one tour, the travel route being travelable within the specified time frame.

5. A travel planning system according to claim 1,
wherein the storage unit is configured to store at least one travel object, each of the at least one travel object being information about a tour, and comprising position information of a meeting place and position information of at least one visiting place, and
wherein the travel planning unit is configured to:
obtain, when the interested visiting place fulfils a given condition, at least one travel object as the interested travel object from the storage unit, each of the obtained interested travel object comprising the interested visiting place and corresponding to the tour; and
generate the travel route by using the position information of the interested visiting place and the position information of the meeting place, which are indicated by the at least one interested travel object, the generated travel route comprising at least one of: the at least one interested visiting place; or the at least one tour, the generated travel route being travelable within the specified time frame.

6. A travel planning system according to claim 4, wherein the travel planning unit is configured to generate the travel route from which duplication between one of the visiting places included in the tour that is represented by a first interested travel object and the interested visiting place that is represented by a second interested travel object is eliminated.

7. A travel planning system according to claim 1, wherein the travel planning unit is configured to generate the travel route comprising the at least one interested visiting place, being travelable within the specified time frame, and allowing the user to spend a time at each of the at least one interested visiting place, at least as long as a given utilization time associated with the each of the at least one interested visiting place.

8. A travel planning system according to claim 1,
wherein the operation reception unit is configured to output a timetable, which indicates the generated travel route and in which areas representing the respective interested travel objects are arranged, and is configured to receive from the user a selection of an area prohibited to change a place out of the areas, and
wherein the travel planning unit is configured to modify the travel route while maintaining placement of the interested travel object corresponding to the selected area.

9. A travel planning system according to claim 8,
wherein the operation reception unit is configured to receive from the user an instruction to add an area representing the interested travel object in the timetable, and is configured to receive a selection of the added area as the area prohibited to change the place, and
wherein the travel planning unit is configured to modify the travel route in which the interested travel object corresponding to the added area is included, while maintaining the placement of the interested travel object corresponding to the selected area.

10. A travel planning system according to claim 3,
wherein each of the interested travel object comprises a score, which is given by the user,
wherein the travel planning unit is configured to generate a plurality of travel routes for the selected entry zone and exit zone, calculate an evaluation value for each of the plurality of travel routes by using the score, and select a travel route based on the calculated evaluation value, and
wherein the operation reception unit is configured to output the selected travel route and the evaluation value of the selected travel route.

11. A travel planning system according to claim 3, wherein the travel planning unit is configured to generate the travel route comprising the selected entry zone, the at least one interested visiting place, the selected exit zone, and a necessary time slot to which the user is allowed to set a visiting place, and being travelable within the specified time frame.

12. A travel planning system according to claim 11,
wherein the storage unit is configured to store at least one travel object, each of the at least one travel object being information about a visiting place and comprising position information of the visiting place,
wherein the operation reception unit is configured to output a timetable, which indicates the generated travel route and in which an area representing the necessary time slot is included, and is configured to receive from the user a selection of the area,
wherein the travel planning unit is configured to obtain at least one travel object corresponding to the visiting place when the area is selected, and
wherein the operation reception unit is configured to output a list of visiting places represented by the at least one obtained travel object.

13. A travel planning system according to claim 12, wherein the travel planning unit is configured to determine, when the area is selected, whether or not the visiting place fulfilling a first condition is included in the generated travel route, and is configured to obtain at least one travel object corresponding to the visiting place that fulfills a second condition when no visiting place fulfilling the first condition is included in the generated travel route.

14. A travel planning system according to claim 12,
wherein the storage unit is configured to store at least one travel object, each of the at least one travel object being information about a tour, and comprising position information of a meeting place and position information of the at least one visiting place,
wherein the operation reception unit is configured to receive, from the user, an instruction to set the visiting place to the selected area,
wherein the travel planning unit is configured to obtain, from the storage unit, when the visiting place received from the user fulfills a given condition, at least one travel object corresponding to the tour in which the received visiting place is included, and
wherein the operation reception unit is configured to output a list of tours indicated by the at least one obtained travel object.

15. A travel planning system according to claim 1,
wherein the storage unit is configured to store the at least one interested travel object for each of a plurality of users who belong to the same group, and
wherein the travel planning unit is configured to:
obtain, when generating the travel plan for the group, at least one interested travel object of the group by consolidating the same interested travel object of the plurality of users who belong to the group into one; and
generate the travel route by using the position information of the at least one interested visiting place that is represented by the interested travel object obtained for the group, the generated travel route comprising the at least one interested visiting place and being travelable within a specified time frame, which is specified by the group.

16. A travel planning system according to claim 15,
wherein each of the interested travel object comprises a score given by the user,
wherein the travel planning unit is configured to:
calculate, when generating the travel plan for the group, the score of the consolidated interested travel object from the scores given by the plurality of users; and
generate a plurality of travel routes, calculate, for each of the plurality of generated travel routes, an evaluation value from the score, and select one of the plurality of generated travel routes based on the calculated evaluation value, and
wherein the operation reception unit is configured to output the selected one of the plurality of generated travel routes and the evaluation value of the selected one of the plurality of generated travel routes.

17. A travel planning method, which is executed by a travel planning system, the travel planning method comprising:
obtaining at least one interested travel object, each of the at least one interested travel object being information about an interested visiting place of a user and comprising position information of the interested visiting place;
generating a travel plan comprising a travel route, by using the position information of the at least one interested visiting place, which is indicated by the interested travel object, the travel route comprising at least one interested visiting place and being travelable within a specified time frame that is specified by the user; and outputting the generated travel plan.
